(19) United States
(12) Patent Application Publication
(10) Pub. No.: US 2008/0091450 A1
(43) Pub. Date: Apr. 17, 2008

(54) Act support program, method, and apparatus

(75) Inventors: Jun Arima, Kawasaki (JP); Takanori Ugai, Kawasaki (JP); Kouji Aoyama, Kawasaki (JP); Noriyuki Kobayashi, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/699,964

(22) Filed: Jan. 29, 2007

(30) Foreign Application Priority Data
Oct. 12, 2006 (JP) 2006-278689

(51) Int. Cl. G06Q 99/00

(52) U.S. Cl. 705/1

(57) ABSTRACT

In a display area of a display, a KPT screen in which a theme area, a keep area (Keep), a problem area (Problem), and a try area (Try) are disposed is displayed. When a click of the area is detected, a new generation menu of an article corresponding to the area is displayed so as to enable an editing operation of new generation of an article by menu selection. When a click of an article display which is displayed in a tag image in the problem area is detected, new generation menus of articles of the other areas are displayed in addition to a correction menu and a deletion menu of the specified article, so as to enable new generation of an article of another area, for example, the try area in association with the clicked article display.

This application is a priority based on prior application No. 2006-278689, filed Oct. 12, 2006, in Japan.

### BACKGROUND OF THE INVENTION

1. Field of the Invention

The present invention relates to improvement act support program, method, and apparatus used when improvement measures for business operations or the like are examined by brainstorming or the like by members of a group or a team, and particularly relates to improvement act support program, method, and apparatus which are utilized for examining improvement measures in terms of problems (Problem), improvement tentative measures (Try), and continued improvement measures (Keep) known as the KPT method.

2. Description of the Related Arts

Conventionally, as a method of operation improvement acts in various fields such as designing, manufacturing, and sales in business operations, the KPT method is known. The KPT method is a method in which, when a project team is organized in a business operation, various problems generated in the operations carried out by the team are examined for a certain theme, problematic points are pointed out, and improvement measures are found out through occasions of free discussion such as brainstorming; the act thereof is focused on three examination articles,
Keep: determined continued improvement measures (good points)
Problem: problematic points
Try: improvement tentative measures to be carried out next (points to be carried out next); therefore, it is called the KPT method by taking the initial characters thereof. Specifically, a whiteboard or large-size paper which is separated into three regions of Keep, Problem, and Try is prepared to have a discussion meeting in which every member participates, and each of the members freely writes problematic points on tags for a theme to be improved and attaches them onto the Problem region. Subsequently, solutions or practice methods of the posted problematic points are written on tags and attached onto the Try region. Then, when the articles which are employed as improvement measures among the articles of the Try region and to be continuously carried out are determined, they are moved to the Keep region or rewritten so as to provide improvement measures to be continued.

However, the conventional improvement act utilizing the KPT method have below problems since the act has been carried out by utilizing office equipment and office supplies such as the whiteboard and tag notes. First of all, since it is an act utilizing the physical method in which the whiteboard or the like is divided into three regions of Keep, Problem, and Try and tags on which articles are described are attached thereto, it is difficult to cause the history of the operation improvement act to remain, and removed articles are forgotten when the number of tags is increased, which causes repeated examination of the same thing. In addition, since the history is lost, a background problem for an article disposed in Keep is forgotten, and the reason why such an improvement measure has been employed becomes unknown, which causes the improvement measure employed as Keep to be no longer continued. In addition, although some of Keep articles are expected to improve the productivity of other teams by widely sharing them in a corporate structure, there is a problem that they cannot be utilized since an improvement act is often limited within a team. Furthermore, although Problem articles include problems that cannot be solved by a team but are to be solved by a corporate structure, improvement acts are limited within the team; therefore, there is a problem that the chance of organizational improvement is lost.

### SUMMARY OF THE INVENTION

According to the present invention is to provide improvement act support program, method, and apparatus which computerize information, which is based on the KPT method, accumulate improvement acts as intellectual assets, and can utilize them efficiently.

(Program)

The present invention provides an improvement act support program executed by a computer. The improvement act support program of the present invention is characterized by causing a computer to execute

a display processing step of displaying an improvement act support screen, in which a theme region, a keep region, a problem region, and a try region are disposed, on a display;

an article editing step of processing new generation of articles to be disposed in the theme region, the keep region, the problem region, and the try region, correction of the articles, or deletion of the articles in accordance with an input operation;

a region menu selecting step of, when an operation specifying the problem region, the try region, or the keep region is detected, displaying a new generation menu of an article corresponding to the region and enabling the process of the article editing step when an operation selecting the new generation menu is detected;

an article menu selecting step of, when an operation specifying an article disposed in the problem region, the try region, or the keep region is detected, displaying new generation menus of articles the other regions in addition to a correction menu and a deletion menu of the specified article and enabling the process of the article editing step when an operation selecting any of the menus is detected; and

an accumulation processing step of associating the problem article, the try article, and the keep article by using the theme article as a starting point and storing the articles in a storage unit.

Herein, in the article menu selecting step,

when an operation specifying the problem article disposed in the problem region is detected, new generation menus of a try article of the try region and a keep article of the keep region are displayed in addition to a correction menu and a deletion menu of the specified problem article;

when an operation specifying the try article disposed in the try region is detected, new generation menus of a problem article of the problem region and a keep article of the keep region are displayed in addition to a correction menu and a deletion menu of the specified try article; and,

when an operation specifying the keep article disposed in the keep region is detected, new generation menus of a problem article of the problem region and a try article of the try region are displayed in addition to a correction menu and a deletion menu of the specified keep article.

The article editing step causes

a theme article editing step of processing new generation, correction, or deletion of the theme article to be disposed in the theme region in accordance with an input operation;

a problem article editing step of processing new generation of the problem article of a tag image in which a problematic point or the like is described which is to be disposed in the problem region, correction of the problem article, or deletion of the problem article in accordance with an input operation;

a try article editing step of processing new generation of the try article of a tag image in which an improvement measure or the like to be tried next is described which is to be disposed in the try region, correction of the try article, or deletion of the try article in accordance with an input operation; and

a keep article editing step of processing new generation of the keep article of a tag image in which an improvement measure or the like determined to be continued is described which is to be disposed in the keep region, correction of the keep article, or deletion of the keep article in accordance with an input operation to be executed.

In the article editing step, new generation, correction or deletion of a theme article disposed in the theme region is processed in accordance with an input operation; and,

in the region menu selecting step, when an operation specifying the theme region is detected, a correction menu of a theme article is displayed, and, when an operation selecting the correction menu is detected, the process of the article editing step is enabled.

In the accumulation processing step, for each article, attribute information indicating an identifier, a link relation with another article, an article content (title), an article explanation, generation date and time, disappearance date and time, screen display coordinates, etc. is stored.

The improvement act support program of the present invention is characterized by further executing a search step of searching the storage unit based on an input search condition and displaying a search result.

The search step includes an article search step of searching the storage unit based on an input article search condition and displaying a search result in a list of an article matched with the search condition.

The search step includes a trace search step of searching the storage unit based on an operation specifying an article on the improvement act support screen and an input article search condition, tracing a link relation starting from the specified article so as to search an article matched with the search condition, and displaying a list of the article.

The search step includes an uncompleted problem search step of searching a problem article of which end is not a keep article by tracing a link relation of each article starting from the theme article and displaying the problem article as an uncompleted problem article in a list in the chronological order of generation time.

The search step includes a keep rate search step of detecting a total article number N at ends by tracing all link relations starting from the theme article, detecting a keep article number n of keep articles at the ends, and obtaining and displaying a keep rate (n/N) which is the keep article number n divided by the total article number N.

The search step includes an update frequency search step of extracting generation date and time of each article by tracing all link relations starting from the theme article, ordering the date and time in the order of time, calculating mean generation time from mean of the difference between adjacent generation date and time, calculating elapsed time from generation date and time of the theme article until generation date and time of a last article, and displaying the mean generation time and the elapsed time in a list.

(Method)

The present invention provides an improvement act support method. The improvement act support method of the present invention is characterized by including

a display processing step of displaying an improvement act support screen, in which a theme region, a keep region, a problem region, and a try region are disposed, on a display;

an article editing step of processing new generation of articles to be disposed in the theme region, the keep region, the problem region, and the try region, correction of the articles, or deletion of the articles in accordance with an input operation;

a region menu selecting step of, when an operation specifying the problem region, the try region, or the keep region is detected, displaying a new generation menu of an article corresponding to the region and enabling the process of the article editing step when an operation selecting the new generation menu is detected;

an article menu selecting step of, when an operation specifying an article disposed in the problem region, the try region, or the keep region is detected, displaying new generation menus of articles of the other regions in addition to a correction menu and a deletion menu of the article and enabling the process of the article editing step when an operation selecting any of the menus is detected; and

an accumulation processing step of associating the problem article, the try article, and the keep article by using the theme article as a starting point and storing the articles in a storage unit.

(Apparatus)

The present invention provides an improvement act support apparatus. The improvement act support apparatus of the present invention is characterized by having

a display processing unit which displays an improvement act support screen, in which a theme region, a keep region, a problem region, and a try region are disposed, on a display;

an article editing unit which processes new generation of articles to be disposed in the theme region, the keep region, the problem region, and the try region, correction of the articles, or deletion of the articles in accordance with an input operation;

a region menu selecting unit which, when an operation specifying the problem region, the try region, or the keep region is detected, displays a new generation menu of an article corresponding to the region and enables the process of the article editing unit when an operation selecting the new generation menu is detected;

an article menu selecting unit which, when an operation specifying an article disposed in the problem region, the try region, or the keep region is detected, displays new generation menus of articles of the other regions in addition to a correction menu and a deletion menu of the specified article and enables the process of the article editing unit when an operation selecting any of the menus is detected; and

an accumulation processing unit which associates the problem article, the try article, and the keep article by using the theme article as a starting point and stores the articles in a storage unit.

According to the present invention, by executing programs by the personal computers that team members have, an improvement act support screen in which a theme region, a keep region, a problem region, and a try region are disposed is displayed in each of the displays thereof; display, update, and accumulation of the latest state of articles of the keep, problem, and try in an improvement act based on the KPT method can be electronically realized by an editing function based on input operations; an easy-to-read state is always maintained by organizing articles by editing operations through an improvement act; and even when articles are deleted, they can be reproduced and displayed in accordance with needs.

Particularly, since it is an editing operation utilizing the improvement act support screen in which the theme region, the keep region, the problem region, and the try region are disposed, when an operation specifying a disposed article such as a mouse-click is detected, in addition to menus of correction and deletion of the specified article, new generation menus of the other regions are displayed and can be selected; therefore, for example when a try article is desired to be input as an improvement measure for a certain problem article (problematic point) disposed in the problem region, new generation of the try article can be selected by a menu when the problem article serving as a cause is clicked; and, as a result, an input operation of the try article associated with the problem article can be readily realized.

Moreover, when the information of associated problem articles, try articles, and keep articles starting from a theme article and accumulated in a storage unit is searched, the articles of the keep, problem regions, and try can be cross-sectorally searched by setting of search conditions such as a theme or a project; therefore, keep articles and try articles can be shared not only in the team but also organizationally, and problems to be solved (problematic points) according to problem articles can be organizationally extracted.

Moreover, by trace search serving as a search function in which link relations are traced starting from a specified article so as to search the articles matched with search conditions and display the articles in a list, the problem article which is the origin of a keep article or a try article can be found; and, for example, when the reason to continue the keep article is understood, the improvement measure of the keep article can be continued.

Moreover, when the problem articles of which ends are not keep articles are searched by tracing the link relations of articles starting from a theme article, and they are displayed in the chronological order of generation time as uncompleted problem articles, the problem articles that are unsolved problematic points not lead to keep articles, which are improvement measures, over a long period of time can be extracted, and the problems (problematic points) which are difficult to be solved by the team and to be organizationally worked out can be refined.

Moreover, when the total article number N at ends is detected by tracing all the link relations starting from a theme article and the keep article number n of keep articles at the ends are detected, and the keep rate (n/N) which is the keep article number n divided by the total article number N is obtained and displayed, the rate that each problem article or try article is shifted to a keep article can be understood, and the improvement act according to the KPT method can be evaluated by the keep rate.

Furthermore, all the link relations are traced starting from a theme article so as to extract generation date and time of the articles and order them in the order of time, mean generation time is calculated from the mean of differences between adjacent generation date and time, and the elapsed time from the generation date and time of the theme article until the generation date and time of a last article is calculated and displayed, the improvement acts in which update of articles is retarded to some extent can be understood, and it can be utilized in promotion of KPT acts. The above and other objects, features, and advantages of the present invention will become more apparent from the following detailed description with reference to the drawings.

### BRIEF DESCRIPTION OF THE DRAWINGS

FIG. 1 is a block diagram of a system environment to which an embodiment of the present invention is applied;

FIG. 2 is a block diagram of another system environment to which the embodiment of the present invention is applied;

FIGS. 3A and 3B are block diagrams showing a functional configuration of an improvement act support process in the present embodiment;

FIG. 4 is an explanatory diagram of a KPT operation screen used in the present embodiment;

FIG. 5 is an explanatory diagram of a KPT operation screen displayed during an improvement act;

FIGS. 6A and 6B are explanatory diagrams of editing menu display in the case in which section areas of theme, problem, try, and keep in the KPT operation screen are mouse-clicked;

FIG. 7 is an explanatory diagram of editing menu display of the case in which articles on the KPT operation screen are mouse-clicked;

FIGS. 8A and 8B are explanatory diagrams of a KPT operation screen when new generation of try article is selected from an editing menu generated by mouse-clicking a problem article and processed;

FIG. 9 is an explanatory diagram of a KPT operation screen in which an article is newly generated by a drag-and-drop operation;

FIGS. 10A and 1B are explanatory diagrams of the improvement act data table stored in the storage unit of FIGS. 3A and 3B;

FIG. 11 is an explanatory diagram of a tree structure of article records generated from link attribute of the improvement act data table of FIGS. 10A and 10B;

FIG. 12 is a block diagram showing a hardware environment of a computer in which an improvement act support program of the present invention is executed;

FIG. 13 is a flow chart showing an improvement act support process of the present embodiment;

FIG. 14 is a flow chart showing details of the theme generating process of step S3 of FIG. 13;

FIG. 15 is a flow chart showing details of the theme invoking process of step S6 FIG. 13;

FIG. 16 is a flow chart showing details of the theme deleting process of step S9 of FIG. 13;

FIGS. 17A to 17C are flow charts showing details of the article editing processes of steps S4 and S7 of FIG. 13;

FIGS. 17A to 17C are flow charts showing the article editing process subsequent to FIGS. 17A to 17C;

FIG. 18 is a flow chart showing details of article correcting process of step S14 of FIGS. 17A to 17C;

FIG. 19 is a flow chart showing details of the article deleting process of step S16 of FIGS. 17A to 17C;

FIG. 20 is a flow chart showing details of the article generating process of other section area of step S18 of FIGS. 17A to 17C;

FIG. 21 is a flow chart showing details of the search process of step S11 of FIG. 13;

FIG. 22 is a flow chart showing details of article search process of step S3 of FIG. 21;

FIG. 23 is a flow chart showing details of the trace search process of step S5 of FIG. 21;

FIG. 24 is a flow chart showing details of the uncompleted problem search process of step S7 of FIG. 21;

FIG. 25 is a flow chart-showing details of the keep rate search process of step S9 of FIG. 21; and

FIG. 27 is a flow chart showing details of the update frequency search process of step S11 of FIG. 21.

### DETAILED DESCRIPTION OF THE PREFERRED EMBODIMENTS

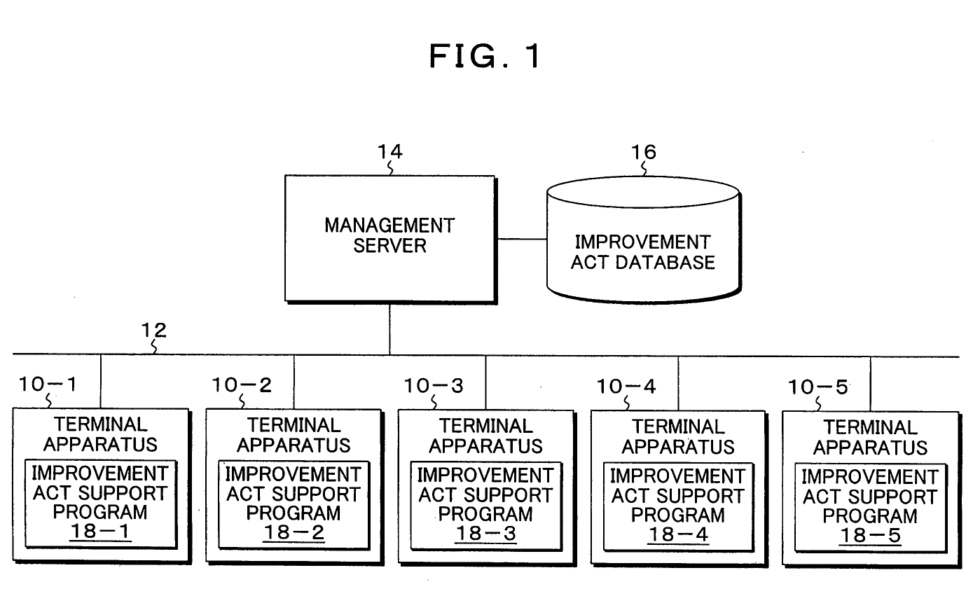

FIG. 1 is a block diagram of a system environment to which an embodiment of an improvement act support process according to the present invention is applied. In FIG. 1, a network system in an organization such as a company is taken as an example, terminal apparatuses 10-1 to 10-5 such as personal computers that members of a project team have are mutually communicatably connected via a network 12, and a management server 14 is connected to the network 12 and manages an improvement act database 16. In the terminal apparatuses 10-1 to 10-5 that the members of the project team have, improvement act support programs 18-1 to 18-5 according to the present embodiment are stored, respectively; and they are started when the project team gathers in a meeting room or the like and brainstorming for an improvement act is to be carried out, and carries out a support process for the improvement act based on the KPT method.

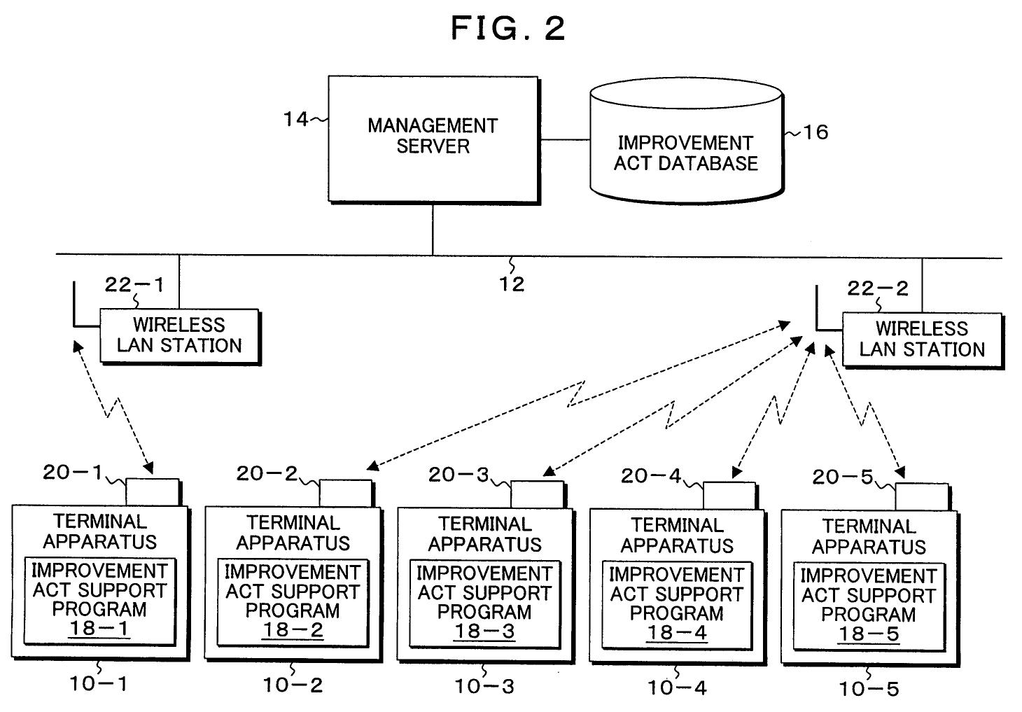

FIG. 2 is a block diagram of another system environment to which the embodiment of the improvement act support process according to the present invention is applied. The system environment of FIG. 2 is characterized by using a wireless LAN. More specifically, the management server 14 to which the improvement act database 16 is connected is connected to the network 12 and, furthermore, to radio LAN stations 22-1 and 22-2. Wireless cards 20-1 to 20-5 are set in the terminal apparatuses 10-1 to 10-5 that the members of the project team have, and a wireless LAN is established when they enter the communication areas of the wireless LAN stations 22-1 and 22-2. As a matter of course, the improvement act support programs 18-1 to 18-5 according to the present embodiment are stored in the terminal apparatuses 10-1 to 10-5, respectively; and they are started and utilized upon an improvement act by means of brainstorming according to the KPT method.

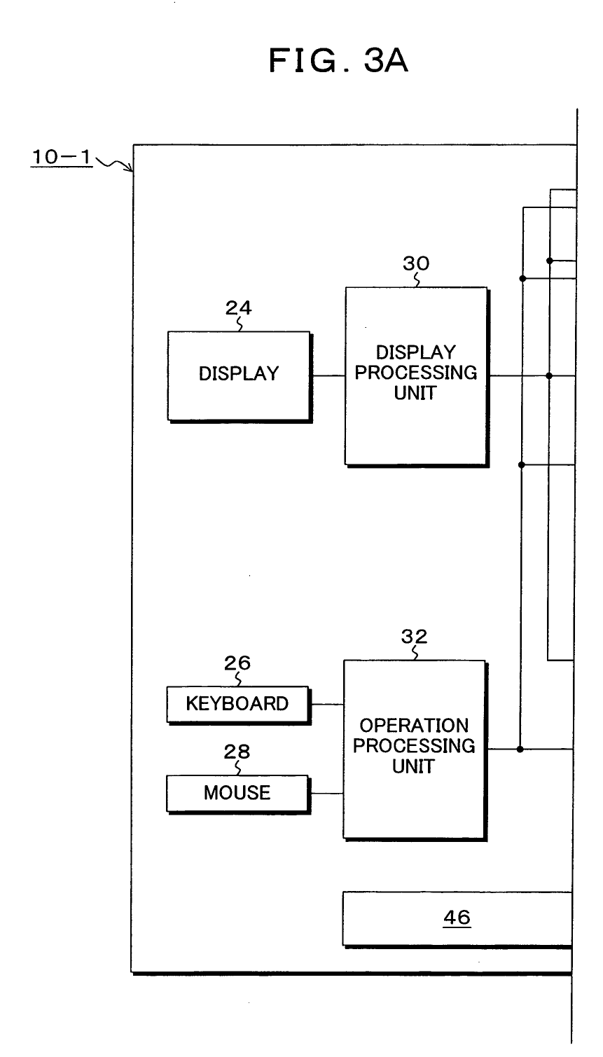

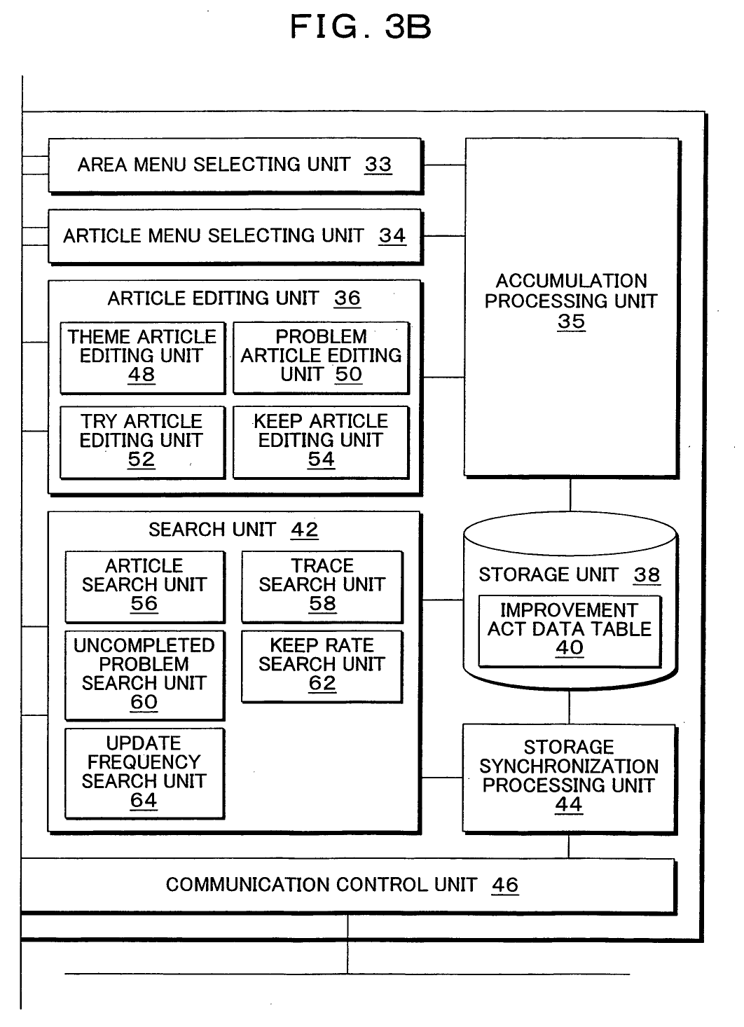

FIGS. 3A and 3B are block diagrams showing a functional configuration of the terminal apparatus used as an improvement act support apparatus in the present embodiment. In FIGS. 3A and 3B, the terminal apparatus 10-1 shown in FIG. 1 and FIG. 2 is taken as an example, and functions realized by execution of the improvement act support program 18-1 of the present embodiment stored in the terminal apparatus 10-1 are shown. In FIGS. 3A and 3B, a display processing unit 30 and an operation processing unit 32 are provided in the terminal apparatus 10-1, a display 24 is connected to the display processing unit 30 as hardware, and a keyboard 26 and a mouse 28 are connected to the operation processing unit 32 as hardware. The display processing unit 30 displays, in the display region of the display 24, a KPT operation screen which functions as an improvement act support screen in which a theme area, a keep area, a problem area, and a try area are separately disposed.

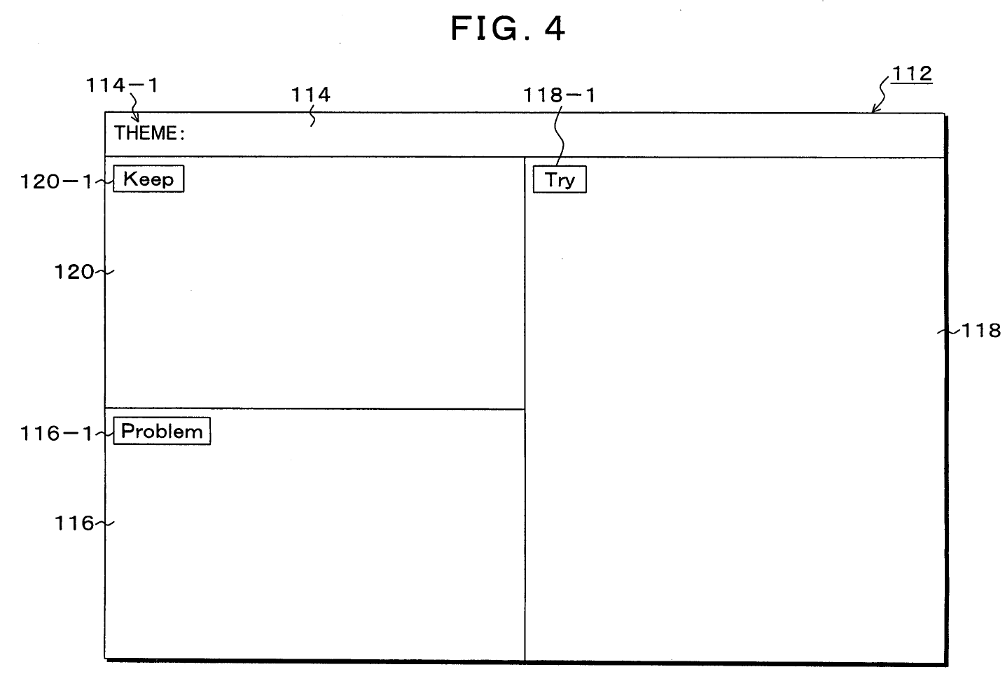

FIG. 4 is an explanatory diagram of the KPT operation screen in the present embodiment. In FIG. 4, the theme area 114 is set in an upper part of the KPT operation screen 112, and “theme (Theme)” is provided therein as an area title 114-1 so that a theme substance which serves as an issue in an improvement act can be input. Below the theme area 114, separately in three parts, the problem area 116, the try area 118, and the keep area 120 are provided, and area titles 116-1, 118-1, and 120-1 respectively indicating the areas are shown. An improvement act by means of brainstorming according to the KPT method is a method in which a certain theme is examined, problematic points are pointed out, and improvement measures are found out through an occasion of free discussion such as brainstorming. Therefore, in the KPT operation screen 112, first of all, a theme is displayed in the theme area 114, team members mention problematic points (problem) about the theme, and these are displayed as tag image articles in the problem area 116. When the articles of the problematic points are displayed in the problem area 116. Try which is improvement tentative measures (things to be carried out next) next to be done for the articles is examined, and they are displayed as try articles in the try area 118. When improvement tentative measures of the try area 118 are suggested one after another for the problematic points of the problem area 116, examined, and finally determined as means for solving the problems, they are determined as Keep as determined continued improvement measures (good points), and the articles thereof are displayed in the keep area 120.

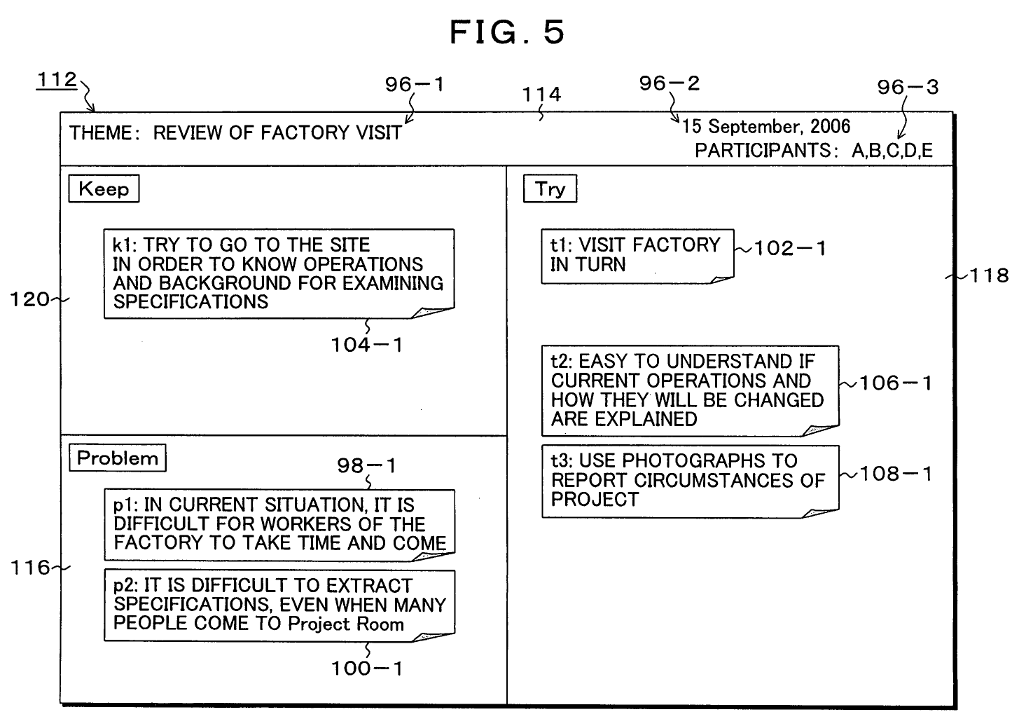

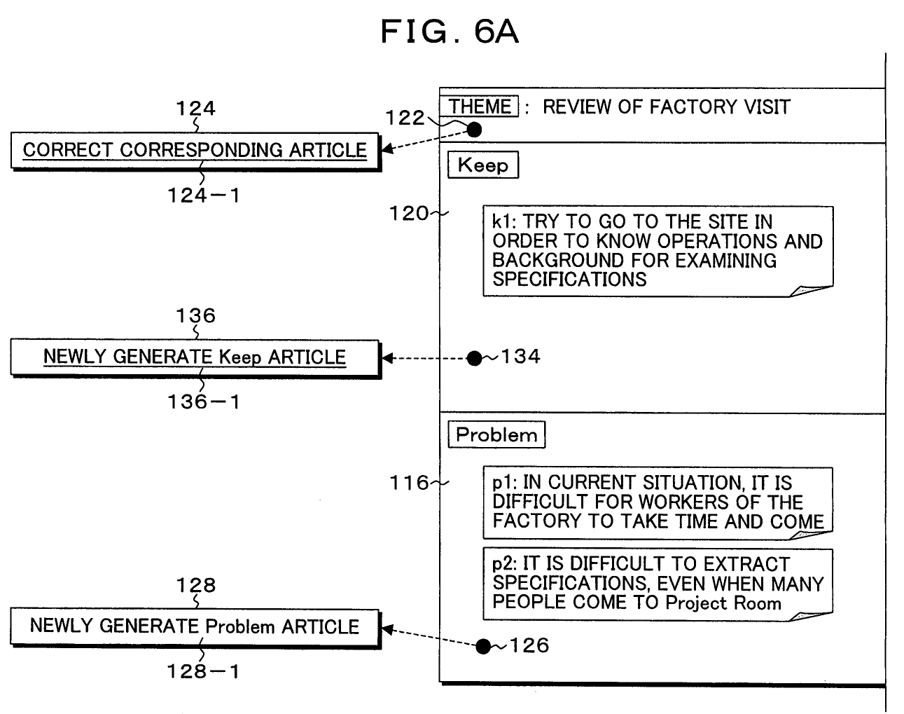

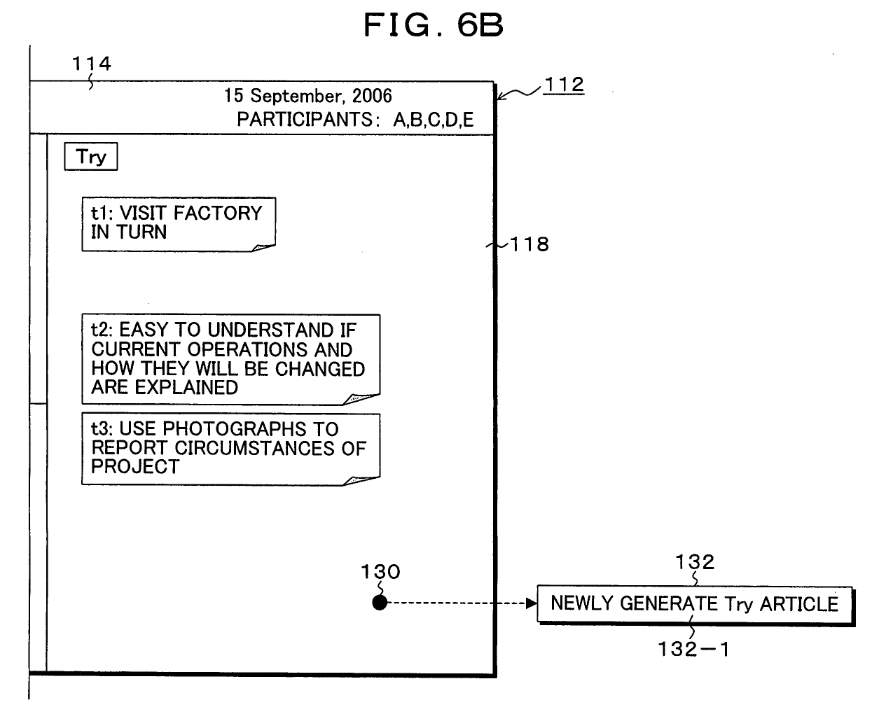

FIG. 5 is an explanatory diagram of the state in which an improvement act of a project team according to the KPT method is progressed to a certain extent with respect to the KPT operation screen 112 of FIG. 4, wherein “REVIEW OF FACTORY VISIT” is displayed as a title 96-1 in the theme area 114, subsequent to that, “15 Sep. 2006” is displayed as generation year, month, and date 96-2, and “PARTICIPANTS: A, B, C, D, E” is displayed as an explanation 96-3. In the problem area 116, two problem articles 98-1 and 100-1 are displayed. In the try area 118, three try articles 102-1, 106-1, and 108-1 are displayed. Furthermore, in the keep area 120, a keep article 104-1 is displayed. Referring again to FIGS. 3A and 3B, for the display processing unit 30 and the operation processing unit 32, an article menu selecting unit 34, an article editing unit 36, an accumulation processing unit 35, a storage unit 38 storing an improvement act data table 40, a search unit 42, a storage synchronization processing unit 44, and a communication control unit 46 are provided. In the article editing unit 36, functions of a theme article editing unit 48, a problem article editing unit 50, a try article editing unit 52, and a keep article editing unit 54 are provided. In the search unit 42, functions of an article search unit 56, a trace search unit 58, an uncompleted problem search unit 60, a keep rate search unit 62, and an update frequency search unit 64 are provided. The article editing unit 36 processes new generation, correction, or deletion of articles in the theme area 114, the problem area 116, the try area 118, and the keep area 120 in the KPT operation screen 112 shown in FIG. 4 in accordance with input operations from the operation processing unit 32 using the keyboard 26 or the mouse 28. Specifically, the theme article editing unit 48 processes new generation, correction, or deletion of a theme article in the theme area 114 of FIG. 4 in accordance with an input operation. The problem article editing unit 50 processes, for example, as shown in the problem area 116 of FIG. 5, new generation or correction or deletion after generation of the problem articles 98-1 and 100-1 of the tag image in which problematic points are described in accordance with an input operation. The try article editing unit 52 processes, for example, as shown in the try area 118 of FIG. 5, new generation or correction or deletion after generation of the try articles 102-1, 106-1, and 108-1 of the tag images, in which improvement measures which are next to be tried for the problematic points of the problem articles 98-1 and 100-1 of the problem area 116 are described, in accordance with an input operation. Furthermore, the keep article editing unit 54 processes, as shown in the keep area 120 of FIG. 5, new generation or correction or deletion after generation of the keep article 104-1 of a tag image, in which determined improvement measures to be continued are described, in accordance with an input operation. Normally, in the KPT method, generation and correction is repeated in the order of problem articles, try articles, and keep articles; therefore, the keep articles are generated based on the try articles, and the keep article editing unit 54 may newly generate new keep articles or, for example when a try article is used as a keep article without modification, may move the try article of the try area 118 to the keep area 120 by drag-and-drop on the KPT operation screen 112. For example, in the case in which the KPT operation screen 112 of FIGS. 6A and 6B is taken as an example, when a specifying operation of the problem area 116, the try area 118, or the keep area 120, specifically, a click operation at a click point 126, 130, or 134 in respective area by mouse-click is detected, the area menu selecting unit 33 displays an area menu window 128, 132, or 136 for newly generating an article corresponding to the area; and, when each of the menus 128-1, 132-1, or 136-1 is selected, new generation of an article by the article editing unit 36 of FIGS. 3A and 3B, i.e., new generation of an article by user input can be accepted.

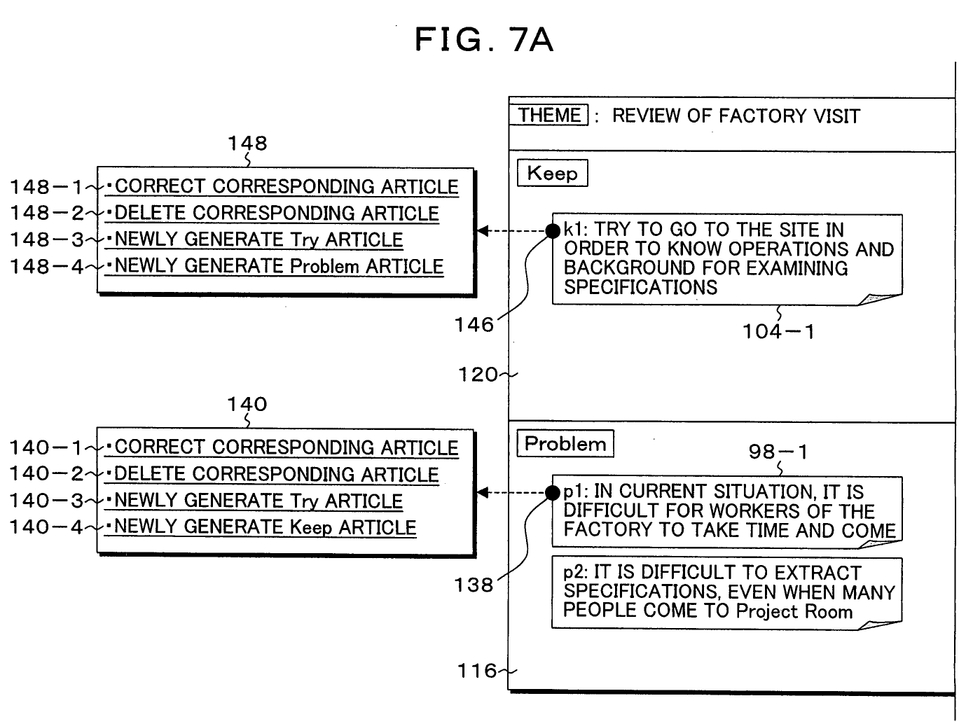

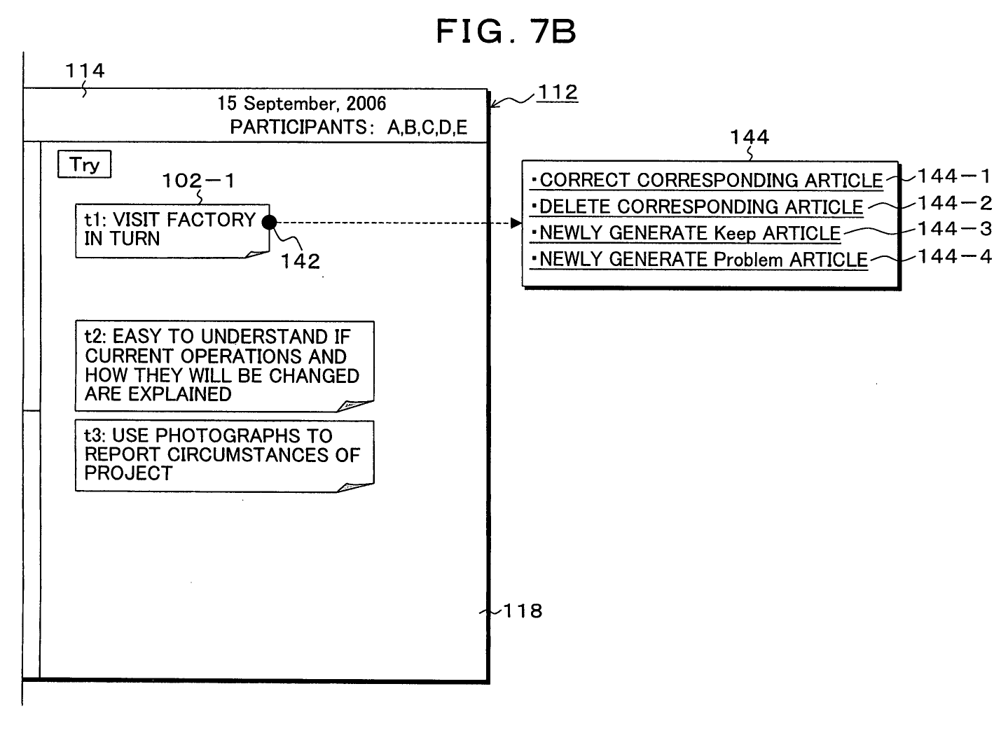

In FIGS. 6A and 6B, when the click point 126 of the problem area 116 is mouse-clicked, the area menu window 128 is displayed, and “PROBLEM ARTICLE NEW GENERATION” is displayed as the menu 128-1. When, for example, the click point 130 of the try area is mouse-clicked, the area menu window 132 is displayed, and “NEW GENERATION OF TRY ARTICLE” is displayed as the menu 132-1. Furthermore, for example, when the click point 134 of the keep area 120 is mouse-clicked, the area menu window 136 is displayed, and “NEW GENERATION OF KEEP ARTICLE” is displayed as a menu 136-1. Furthermore, when the theme area 114 of FIGS. 6A and 6B is clicked for example as shown by a click point 122, the area menu selecting unit 33 of FIGS. 3A and 3B displays a menu window 124, and “CORRECTION OF CORRESPONDING ARTICLE” is displayed as a menu 124-1 for correcting the theme substance that is already shown in the menu window 124. For example, as shown in the KPT operation screen 112 of FIG. 7, when mouse-click is performed to specify the region in the article of any of the tag images already displayed in the problem area 116, the try area 118, or the keep area 120, the article menu selecting unit 34 of FIGS. 3A and 3B displays a menu having menu contents of
(1) correction of the specified article,
(2) deletion of the specified article, and
(3) new generation of an article of another area.

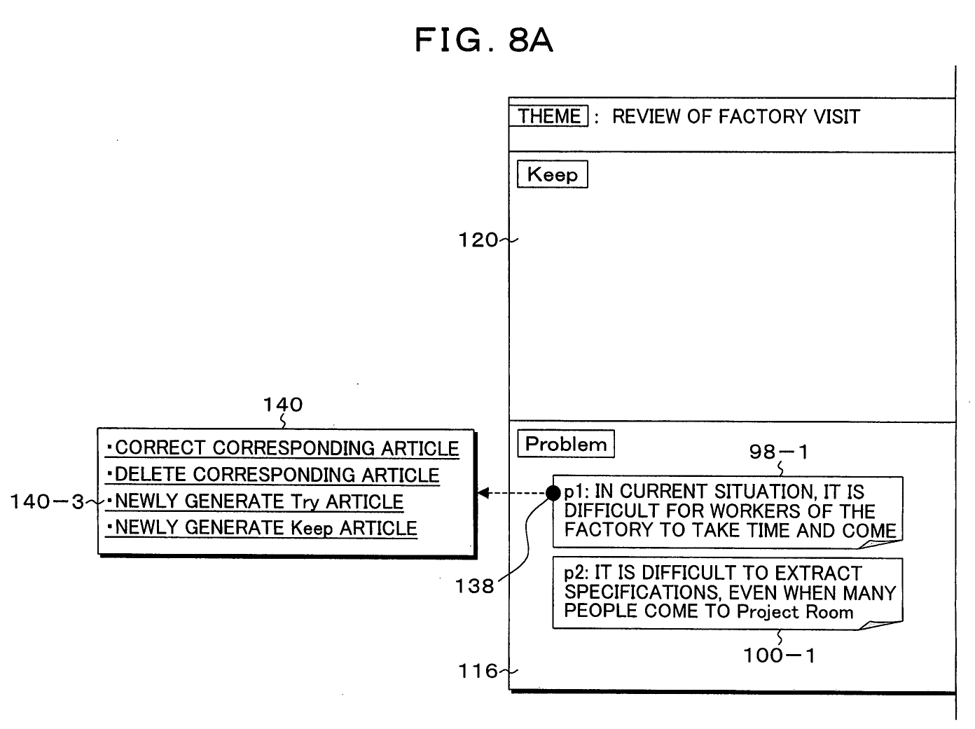

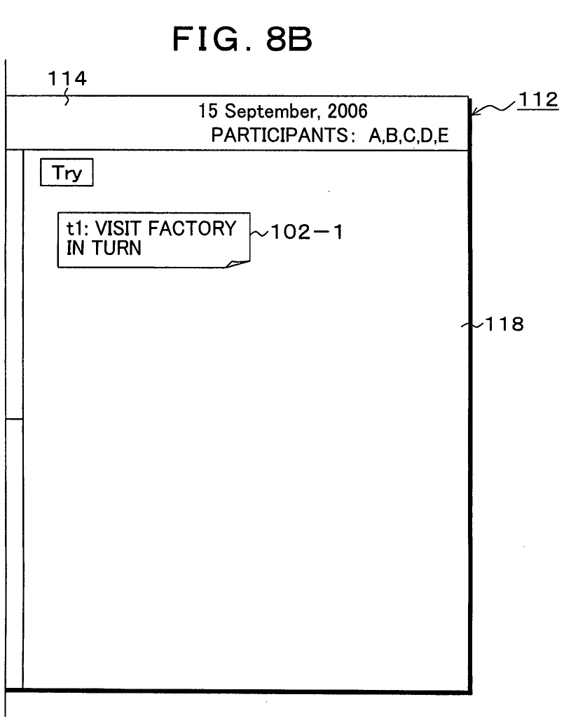

For example, in the KPT operation screen 112 of FIG. 7, when a click point 138 in the problem article 98-1 shown in the problem area 116 is mouse-clicked, an article menu window 140 is shown as separately shown in the left side is displayed. In the article menu window 140, in addition to “CORRECTION OF CORRESPONDING ARTICLE” as a menu 140-1 and “DELETION OF CORRESPONDING ARTICLE” as a menu 140-2, menus of “NEW GENERATION OF Try ARTICLE” and “NEW GENERATION OF Keep ARTICLE” for new generation of articles in the try area 118 and the keep are 120 which are different from the problem area 116 in which the problem article 98-1 is disposed are displayed as menus 140-3 and 140-4. In this manner, the menus of new generation of the articles of the areas different from the area in which the specified-article is present are displayed; consequently, for example when a try article is to be generated for a problematic point shown as an article of the problem area 116, instead of new generation of the try article specifying the try area 118, the try article is newly generated from menu selection specifying the problem article which is the cause thereof; as a result, an improvement act can be carried out while understanding, on the KPT operation screen 112, the link relation between the problem article serving as the cause and the try article newly generated based on that. Specifically, the procedure is as shown in the KPT operation screen 112 of FIGS. 8A and 8B. The KPT operation screen 112 of FIGS. 8A and 8B shows the state in which the problem articles 98-1 and 100-1 are newly generated and disposed in the problem area 116 with respect to the theme of the theme area 114. In this state, when a try article is to be newly generated, for example, for the problematic point of the problem article 98-1, inside of the problem article 98-1 is mouse-clicked, for example, as shown by the click point 138, thereby displaying the article menu window 140. When “NEW GENERATION OF TRY ARTICLE” of the menu 140-3 is clicked in the displayed article menu window 140, an input screen of try article new generation which is not shown is opened, and, by using that, an editing operation of inputting a try which is an improvement measure to be tried next is carried out; thus, new generation of the try article is carried out, and it is displayed as the try article 102-1 in the try area 118. As described above, in an improvement act utilizing the KPT operation screen 112 of the present embodiment, new generation of an article associated with a next article wherein an already generated article serves as a cause can be readily and appropriately carried out by menu deployment in which the existing article is specified by mouse-click or the like.

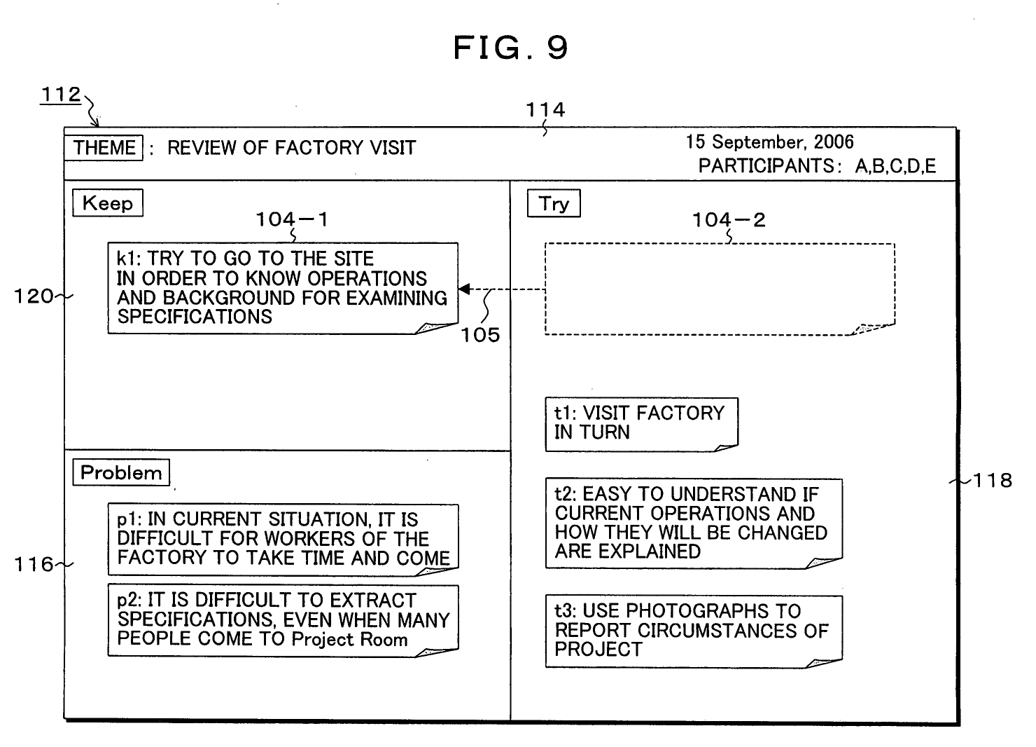

Referring again to FIGS. 3A and 3B, the accumulation processing unit 35 records the data that is for displaying, for example, the KPT operation screen 112 displayed as shown in FIG. 5 as article records in article units in the improvement act data table 40 and reads them in accordance with needs through processes of the area menu selecting unit 33, the article menu selecting unit 34, and the article editing unit 36. Furthermore, as shown in the KPT operation screen 112 of FIG. 9, the article menu selecting unit 34 of FIGS. 3A and 3B can also newly generate an article by moving an article displayed in a certain area to another area by a drag-and-drop operation.

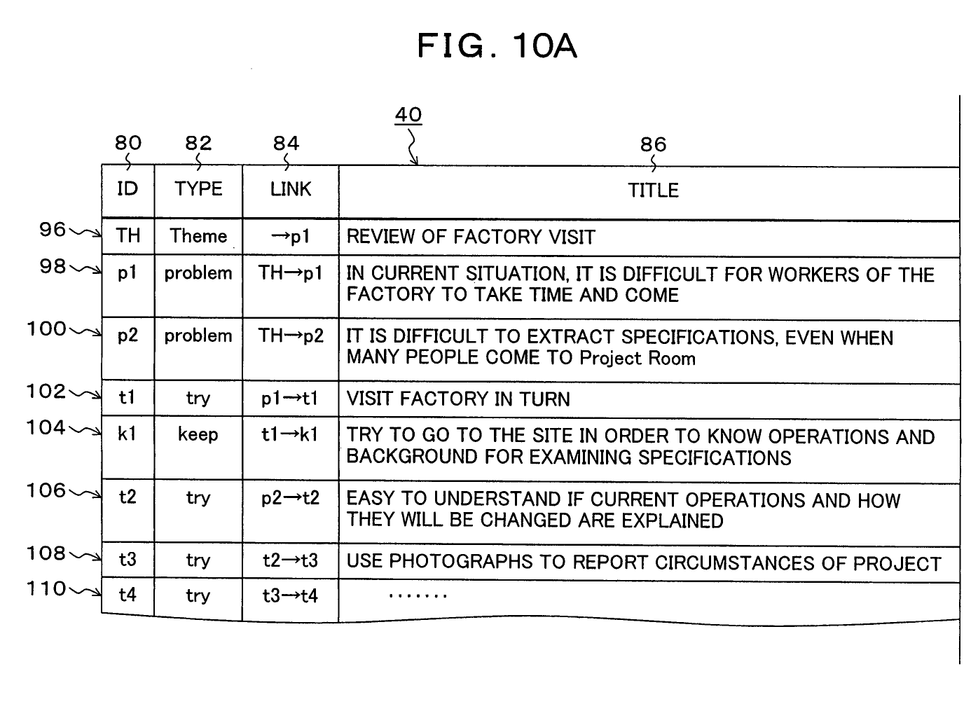

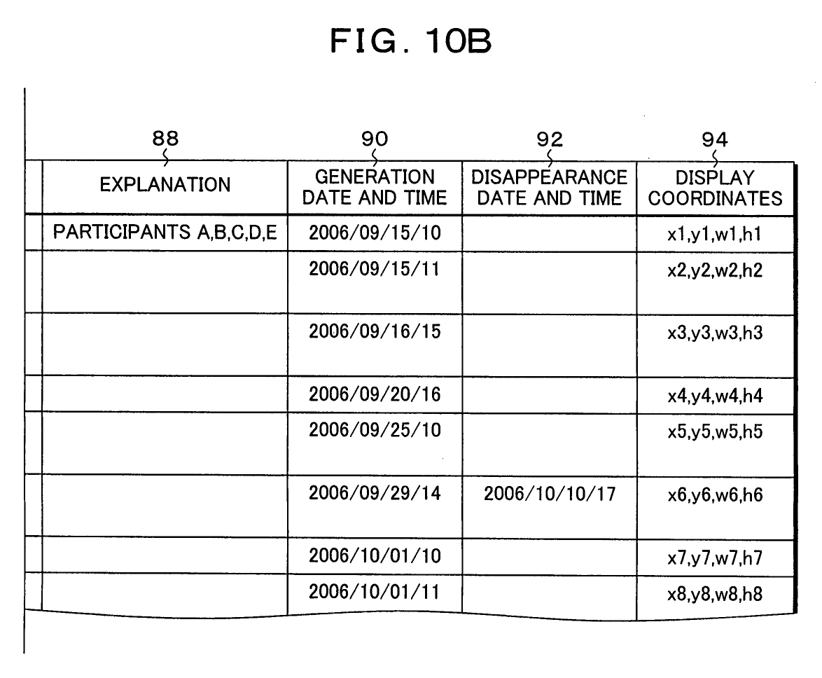

In FIG. 9, a try article 104-2 disposed in the try area 118 is moved to the keep area 120 as shown by an arrow 105 by a drag-and-drop operation by a mouse, thereby newly generating the keep article 104-1. In this case, the try article 104-2 of the movement origin remains without modification; however, it can be deleted after the movement by a deleting operation of the try article 104-2. The keep article 104-1 generated through movement uses the title (display contents) of the movement origin without modification; however, if the contents are desired to be changed, a correcting operation can be carried out. Furthermore, as another mode using the drag-and-drop operation, the article of the movement origin may be automatically deleted. The improvement act data table 40 stored in the storage unit 38 of FIGS. 3A and 3B has the contents of, for example, FIGS. 10A and 10B. The improvement act data table 40 of FIGS. 10A and 10B takes data contents corresponding to the display state of the KPT operation screen 112 shown in FIG. 5 as an example.

In FIGS. 10A and 10B, the improvement act data table 40 records article records including IDs 80 which are identifiers of the articles, types 82 of the articles, links 84 showing the link relations of the articles, titles 86 showing the contents described in article display, explanations 88 which are displayed in the article display in accordance with needs, generation date and time 90 of the articles, disappearance date and time 92 of the articles, and display coordinates 94 of the articles as attribute information respectively for the articles. As stored records of the improvement act data table 40 corresponding to FIG. 5, a theme record 96 is recorded at the top, and, subsequent to that, article records 98, 100, 102, 104, 106, 108, and 110 are recorded. In the top theme record 96, the ID 80 is “TH”, the type 82 is “Theme”, and a link relation is recorded as “p1” as the ID of the article record 98 which is the next link destination since the link 84 is at the top position. The title 86 is the theme substance “REVIEW OF FACTORY VISIT”. In addition, as the explanation 88, “PARTICIPANTS A, B, C, D, E” are recorded as the names of participants in the improvement act. The generation date and time 90 is “2006/09/15/10”. The disappearance date and time 92 is blank since the project is being continued. As the display coordinates 94, a display reference point (x1,y1) of the title 96-1, the generation year, month, and date 96-2, and the explanation 96-3 in the KPT operation screen 112 and a width w1 and a height h1 of the display region on the display screen are recorded. In the next article record 98, the ID 80 is “p1”, the type 82 is “problem”, and a link relation with the ID “TH” of the theme record 96 is recorded as the link 84. Herein, the title 86 and the explanation 88 are recorded by accepting user input utilizing the editing functions; however, the ID 80, the type 82, the link 84, the generation date and time 90, the disappearance date and time 92, and the display coordinates 94 are automatically generated and recorded along with editing operations. It is basically same for the second and following article records 98, 100, 102, 104, 106, 108, and 110; wherein each of them is recorded by receiving input of the title 86 and the explanation 88 thereof by the user utilizing menu selection and the editing functions, and, along with that, the ID 80, the type 82, the link 84, and the generation date and time 90 or the disappearance date and time 92 are automatically generated and recorded. Herein, the generation date and time 90 is recorded for all of the article records 98 to 110; among them, “2006/10/10/17” is recorded as the disappearance date and time 92 for the article record 106; and, after the date and time, display of the try article 106-1 corresponding to the article record 106 is deleted from the KPT operation screen 112 of FIG. 5. However, even when the try article 106-1 is deleted from the screen, the deleted article record 106 remains without modification in the improvement act data table 40. Therefore, when the improvement act data table 40 is referenced, and the record of the disappearance date and time 92 is deleted, the try article 106-1 based on the article record 106 of which display has been deleted can be restored and displayed on the screen again.

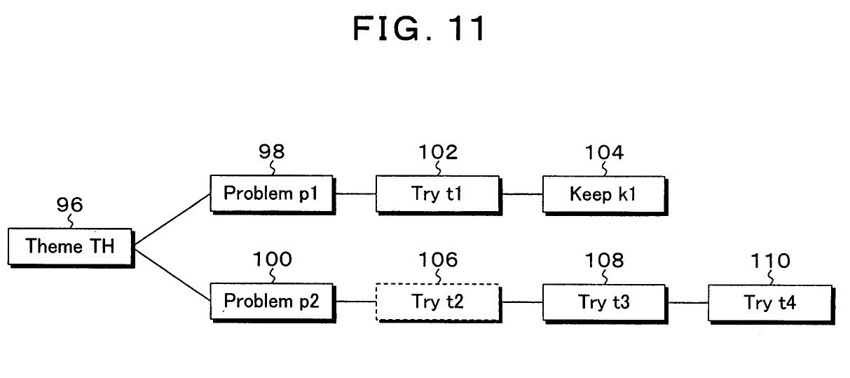

FIG. 11 is an explanatory diagram of a tree structure of the article records generated based on the links 84 of the improvement act data table 40 of FIGS. 10A and 10B. In the tree structure of FIG. 11 showing the link relations, first of all, the theme record 96 is present at the top, and the theme record 96 is branched into two, wherein the article records 98 and 100 of problems are present. With respect to the problem article record 98, the try article record 102 is linked, and the keep record 104 is further linked thereto at the end. Looking at this link relation, it can be understood that problem solution of the problematic point according to the article record 98 is completed by determining keep of the article record 104 through the improvement suggestion according to the article record 102. On the other hand, regarding the problem article record 100, the try article records 106, 108, and 110 are subsequently linked thereto, and the end thereof is the try article record 110; therefore, it is under examination and in the state that a keep that is an improvement measure for the problematic point of the article record 100 has not yet been obtained. The article record 106 is deleted from the screen as shown by broken lines since the disappearance date and time 92 is recorded as shown in FIG. 10; however, the link relation is maintained in terms of the data.

Referring again to FIGS. 3A and 3B, the storage synchronization processing unit 44 provided for the storage unit 38 performs storage synchronization control for causing the contents of the improvement act data table stored in the improvement act database 16 of the management server 14 shown in FIG. 1 and the improvement act data table 40 of the terminal apparatus 10-1 to agree with each other via the communication control unit 46. More specifically, when the improvement act support program of the present embodiment is started in the terminal apparatus 10-1 side to perform an operation, and the improvement act data table 40 is generated by that, newly recording a newly generated theme to the improvement act database 16 is requested to the management server 14 via the communication control unit 46 at predetermined synchronization timing, and the requested new improvement act data table 40 is recorded in the improvement act database 16 with a theme ID or the like serving as an index. After the improvement act data table is newly recorded in the improvement act database 16, when the improvement act support programs 18-1 to 18-5 of the terminal apparatuses 10-1 to 10-5 are started thereafter, acquisition of the improvement act data table is requested to the management server 14, the data table recorded in the improvement act database 16 at that point is read according to the requested theme ID and transferred to each of the terminal apparatuses 10-1 to 10-5, and, for example as shown in the terminal apparatus 10-1 of FIGS. 3A and 3B, the improvement act data table 40 is stored in the storage unit 38 so as to start a support operation. When an article is newly recorded or an article is corrected in the improvement act data table 40 during the support operation, the storage synchronization processing unit 44 requests synchronization to the management server 14 at predetermined synchronization timing and executes update of the corresponding improvement act data table of the improvement act database 16, for example, by transferring merely differential data. By virtue of such synchronization between the improvement act database 16 of the management server 14 and the data table 40 of the terminal apparatus by the storage synchronization processing unit 44, when a terminal apparatus which is connected to the network 12 and is not in the project team accesses the management server 14, the improvement act data table in the improvement act database 16 of another team can be acquired and utilized at any time in accordance with needs. If there is a problem when the improvement act data table retained in the improvement act database 16 through storage synchronization is referenced by other users, a security function using passwords and accounts may be provided so that the improvement act data table can be referenced by merely the people who know the security information. Next, the search unit 42 of FIGS. 3A and 3B will be explained. In the present embodiment, as the search unit 42, the article search unit 56, the trace search unit 58, the uncompleted problem search unit 60, the keep rate search unit 62, and the update frequency search unit 64 are provided. The article search unit 56 searches the improvement act data table 40 of the storage unit 38 based on input search conditions of articles and displays a list of the articles matched with the search conditions as search results. The trace search unit 58 searches the improvement act data table 40 of the storage unit 38 based on a specifying operation of a particular article on the KPT operation screen and input search conditions of articles, searches the articles matched with the search conditions by tracing the link relation starting from the specified article, and display them in a list. By virtue of this trace search, the problem article that is the cause of a keep article or try article can be found; and, when the reason (problematic point) for which, for example, a keep article is to be continued is found out, the improvement measure of the keep article can be continued. The uncompleted problem search unit 60 searches problem articles of which end is not keep articles, i.e., problem articles of which problematic points are not solved by tracing the link relations of the articles starting from and subsequent to the theme article on the KPT operation screen, and display them in a list as uncompleted problem articles in the chronological order of the generation time of the searched problem articles. By virtue of the uncompleted problem search, the problem articles which are unsolved problematic points not lead to keep articles, which are improvement measures, over a long period of time, and, in this case, it can be utilized for refining problems which are difficult to be solved within the project team and to be worked on rather by the whole corporate structure. The keep rate search unit 62 detects the total article number N at ends by tracing all the link relations starting from the theme article, detects the article number n of the keep articles at the ends, calculates a keep rate based on that, and displays it.

Keep Rate=(Keep Article Number n)/(Total Article Number N)

By virtue of the keep rate search, the rate that a certain theme article is shifted to keep articles in an improvement act in a project team for a certain theme can be understood; therefore it can be utilized in evaluation of the improvement act according to the KPT method. The update frequency detection unit 64 extracts the generation date and time of articles and order them in the order of time by tracing all the link relations starting from the theme article, for the list in which they are ordered in the order of time, calculates mean generation time M is calculated by the mean of the differential between adjacent generation date and time, calculates elapsed time T from when the generation date and time of the theme article until the generation date and time of the last article, and displays the mean generation time M and the elapsed time T, which is obtained for each theme in this manner, in a list. By virtue of the update frequency search, when the mean generation time M or the elapsed time T is compared, whether an improvement act which is currently in process is retarded without being progressed or not can be determined, and it can be utilized in promotion of the KPT act.

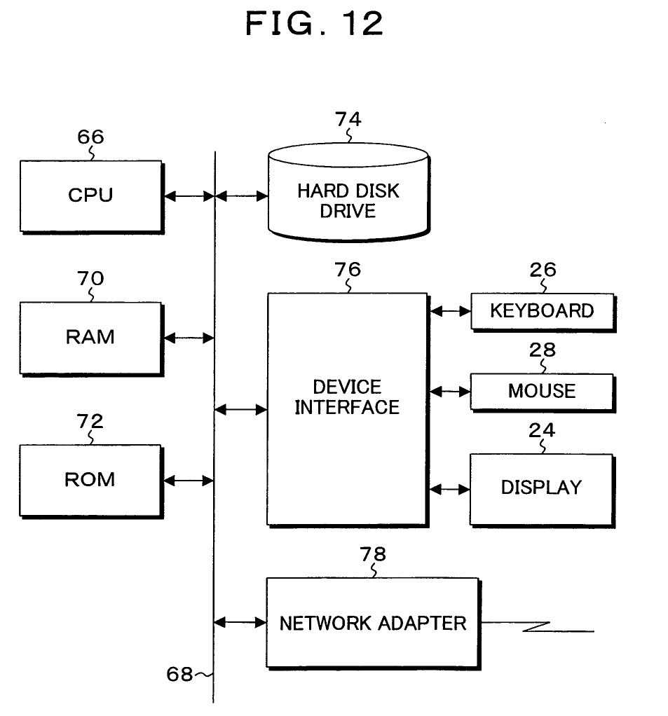

FIG. 12 is a block diagram showing a hardware environment of a computer which constitutes each of the terminal apparatuses 10-1 to 10-5 in which the improvement act support program of the present embodiment is executed. In FIG. 12, to a bus 68 of a CPU 66, a RAM 70, a ROM 72, a hard disk drive 74, a device interface 76 to which a keyboard 26, a mouse 28, and a display 24 are connected, and a network adapter 78 are connected. In the hard disk drive 74, the improvement act support program of the present embodiment is stored, and, after boot-up upon start-up-of the computer, it is read to the RAM 70 as an application program in association with OS deployment and executed by the CPU 66.

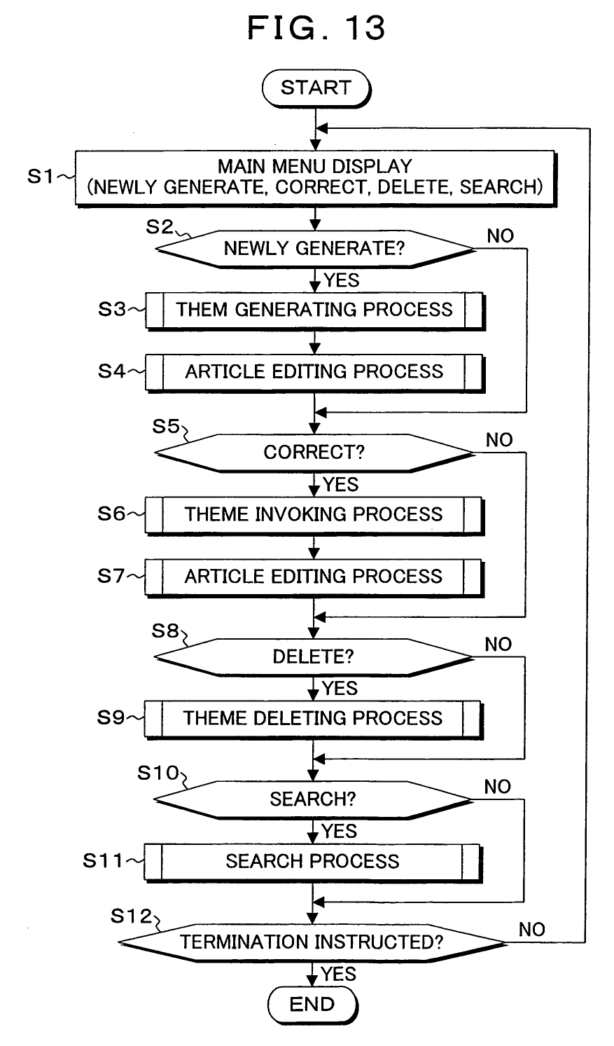

FIG. 13 is a flow chart showing an improvement act support process of the present embodiment, wherein an improvement act support program processing procedure of the present embodiment is shown.

In FIG. 13, in the improvement act support process of the present embodiment, a main menu is displayed on the screen in step S1. The main menu display includes menu items of new generation, correction, deletion, and search. Therefore, a user selects a needed menu item on the screen from the main menu display in step S1 and presses an execution button. Subsequently, when new generation according to the menu selection of the user is determined, a theme generation process is executed in step S3, and, subsequently, an article editing process is executed for the generated theme in step S4. When correction is determined as the menu selected by the user in step S5, the process proceeds to step S6 in which a theme invoking process is performed. When the improvement act data table to be corrected is invoked to deploy a KPT screen, and, subsequently, a needed article editing process is executed in step S7. When it is determined that the menu selected by the user is deletion in step S8, the process proceeds to step S9 in which a deleting process of the improvement data table corresponding to the theme specified by the user. Furthermore, when it is determined that search is selected from the menu in step S10, the process proceeds to step S11 in which a search process is executed. Such processes of steps S1 to S11 are repeated until termination is instructed in step S12.

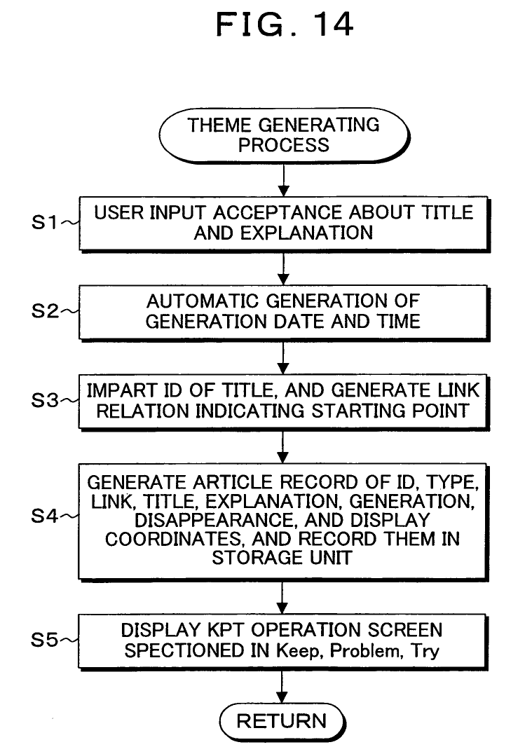

FIG. 14 is a flow chart showing details of the theme generation process in step S3 of FIG. 13. The theme generation process of FIG. 13 will be described below, for example, by taking the theme record 96 in the improvement act data table 40 of FIGS. 10A and 10B as an example. First of all, when a title and an explanation are received through user input using the input screen corresponding to menu selection associated with new generation of the theme by the user in step S1, generation date and time is automatically generated in step S2. Subsequently, in step S3, an ID for the theme record is imparted, and a link indicating a starting point is generated. Subsequently, in step S4, an article record of the ID, type, link, title, explanation, generation date and time, disappearance date and time (blank), and display coordinates is generated and recorded as the improvement act data table 40 in the accumulation processing unit 35 and the storage unit 38. Subsequently, in step S5, the KPT operation screen 112 is displayed separately in the problem area 116, the try area 118, and the keep area 120 as shown in FIG. 4, and the contents corresponding to the title 86 and the explanation 88 in the recorded theme record are displayed in the theme area 114.

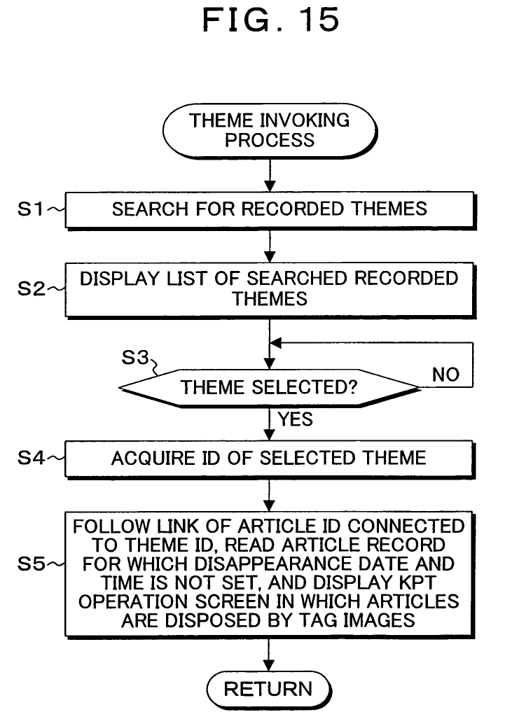

FIG. 15 is a flow chart showing details of the theme invoking process of step S6 of FIG. 13. In FIG. 15, the theme invoking process is operated when the user selects correction in the main menu, and, first of all, recorded themes recorded in the improvement act data table 40 of the storage unit 38 of FIGS. 3A and 3B are searched in step S1. Note that, although the case in which the improvement act data table 40 corresponding to one theme is recorded is taken as an example in FIGS. 3A and 3B, in practice, a plurality of theme records are recorded in the improvement act data table 40 when improvement acts for a plurality of themes are performed. Subsequently, in step S2, a list of the searched recorded themes is displayed, and selection by the user is awaited. When the user selects an arbitrary theme from the displayed theme list, theme selection is determined in step S3, and the ID of the selected theme is acquired in step S4. Subsequently, the process proceeds to step S5 in which the links of the article IDs connected to the acquired theme ID are traced, the article records for which disappearance date and time is not set are invoked, and the articles of the tag images in which the titles and the explanations in the article records are described are displayed in the KPT operation screen. For example, when the theme ID of the theme record 96 of FIGS. 10A and 10B is acquired, the article records 98 to 110 connected to the theme record 96 are invoked as shown in FIG. 11; however, the article record 106 for which the disappearance date and time is recorded is excluded from the objects to be indexed, and the unique nouns of the problem articles, trial articles, and keep articles in which the titles and explanations of the article records having no disappearance date and time are displayed.

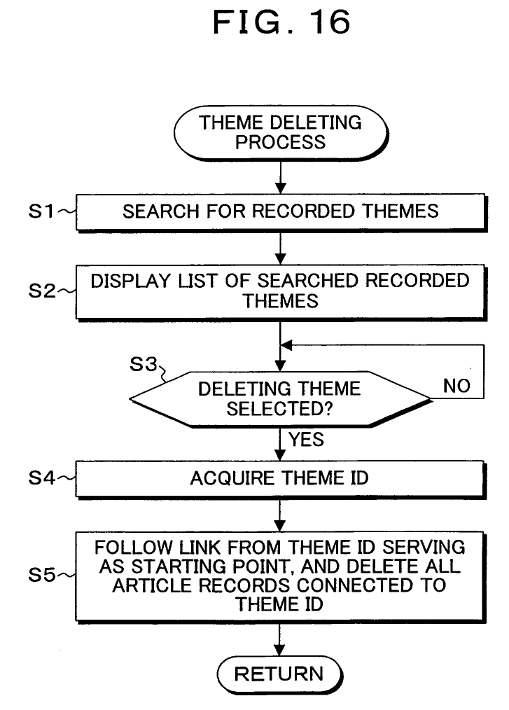

FIG. 16 is a flow chart showing details of the theme deleting process in step S9 of FIG. 13. The theme deleting process is the case in which the user selects “deletion” in the main menu; wherein, first of all, recorded themes are searched in step S1, and the searched recorded themes are displayed in a list in step S2. When the theme to be deleted by the user is selected from the displayed list of the recorded themes, selection of the deleting theme is determined in step S3, and the theme ID is acquired in step S4. Subsequently, in step S5, the improvement act data table is referenced so as to trace the links starting from the theme ID acquired in step S5, and all the article records connected to the theme ID are deleted.

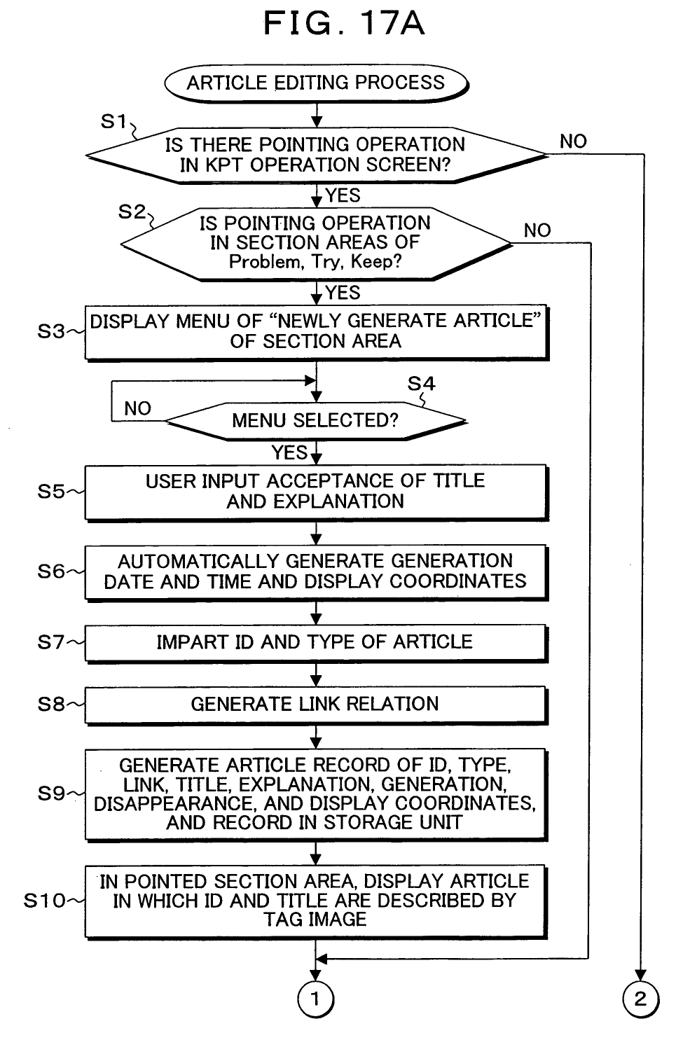

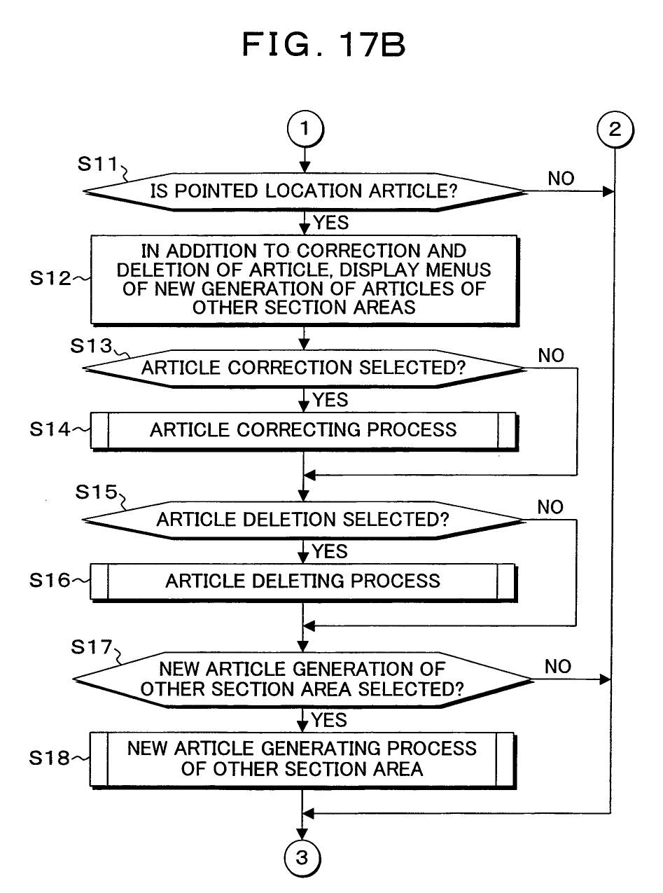

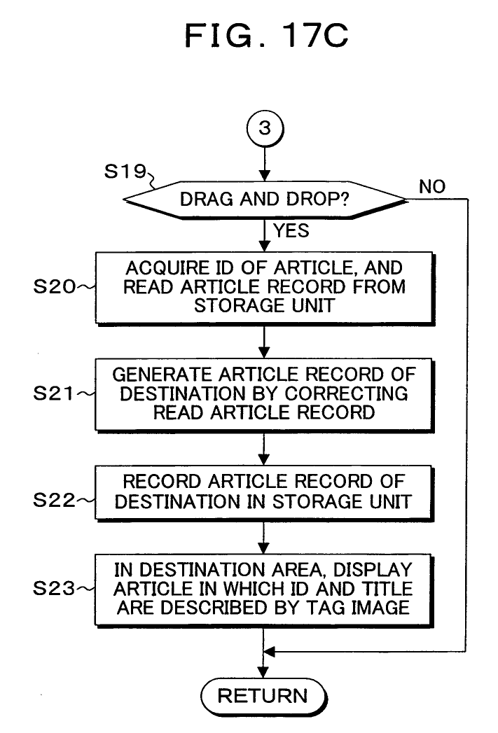

FIGS. 17A to 17C are flow charts showing details of the article editing process in step S4 or S7 of FIG. 13. In FIGS. 17A to 17C, the article editing process is started by a pointing operation by a mouse-click on the KPT operation screen by the user. First of all, when a pointing operation by a mouse-click on the KPT operation screen by the user is determined in step S1, the process proceeds to step S2 in which whether the pointing operation has been performed in any of the section areas composed of the program area, the trial area, and the keep area or not is determined. When it is determined that the pointing operation has been performed in the section area, the process proceeds to step S3 in which the menu of “NEW GENERATION OF ARTICLE” of the section area is displayed. Specifically, as shown in FIGS. 6A and 6B, for example, when a pointing operation by a mouse-click of the click point 126 of the problem area 116 is determined, the area menu window 128 is displayed so as to display the menu of “NEW GENERATION OF PROBLEM ARTICLE”. Subsequently, when menu selection is determined in step S4, the process proceeds to step S5 in which an input screen of article new generation is deployed, and user input of a title and an explanation are accepted. Subsequently, generation date and time and display coordinates are automatically generated in step S6, and the ID and the type of the article are imparted in step S7. Subsequently, a link relation is generated in step S8; then, in step S9, for example as shown in the article record 98 in the improvement data act table 40 of FIGS. 10A and 10B, an article record composed of the ID, type, link, title, explanation, generation date and time, disappearance date and time (blank), and display coordinates is generated and recorded in the improvement act data table 40 of the storage unit 38 of FIGS. 3A and 3B. Subsequently, in step S10, the article in which the ID and the title are described is displayed as a tag image in the sectioned area that is pointed by the mouse click. On the other hand, when the pointing operation is not in the section areas in step S2, the process proceeds to step S11 of FIGS. 17A to 17C in which whether the pointed location is an article or not is determined. When the pointed location is an article, the process proceeds to step S12. In this case, for example as shown by the pointing operation of the click point 138 of the problem article 98-1 in the problem area of the KPT operation screen 112 of FIG. 7, the menus 140-1 to 140-4 of new generation of a try article and a keep article, which are other section areas, are displayed by the menu window 140 in addition to correction and deletion of the corresponding article. When selection of the article correction by the user is determined in this state in step S13, an article correcting process is executed in step S14. When selection of the article deletion is determined in step S15, an article deleting process is performed in step S16. When selection of new generation of an article of another section area is determined in step S17, a new article generating process is executed in step S18.

In step S19 of FIGS. 17A to 17C, a drag-and-drop operation by the user is determined. In step S19, a drag-and-drop operation of the try article 104-2 disposed in the try area 118 to the keep area 120, for example as shown in FIG. 9, is determined, the process proceeds to step S20 in which the ID of the article is acquired, and the article record of the movement origin is read from the data table 40 of the storage unit 38. Subsequently, in step S21, the read article record of the movement origin is corrected, thereby correcting the article record of the movement destination. In the case of FIG. 9, the ID, type, generation date and time, and display coordinates in the article record of the article 104-2 of the movement origin are corrected to the information of the movement destination. Subsequently, in step S22, the article record of the movement destination newly generated by the correction is recorded in the data table 40 of the storage unit 38. Then, in step S23, based on the recorded newly generated article record, the newly generated keep article 104-1 is displayed in the keep area 120 which is the area of the movement destination. In the newly generating process of the article by the drag-and-drop operation, either
mode 1: the article of the movement origin is caused to remain or
mode 2: the article of the movement origin is deleted
   can be selected and set in advance for the article of the movement origin. Herein, in the deletion of the article of the movement origin in mode 2, it can be deleted from the screen by automatically recording the date and time when the drag-and-drop operation is performed on the article record of the movement origin.

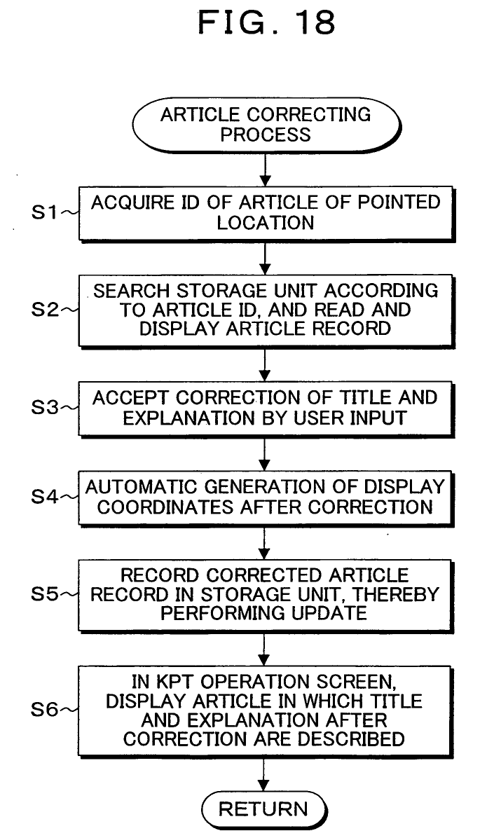

FIG. 18 is a flow chart showing details of the article correcting process in step S14 of FIGS. 17A to 17C. In FIG. 18, in the article correcting process, the article ID of the pointed location is acquired in step S1, and the improvement act data table 40 in the storage unit 38 of FIGS. 3A and 3B is searched according tot he acquired article ID so as to invoke and display the article record corresponding tot he article ID in step S2. After the state in which the article record is invoked and displayed is achieved, correction of the title and explanation by user input is accepted in step S3. After accepting the correction, display coordinates after the correction are automatically generated in step S4. Subsequently, in step S5, the corrected article record is recorded in the storage unit 38 so as to update the corresponding record of the improvement act data table 40. Subsequently, in step S6, the article in which the title and explanation after the correction are described is displayed in the KPT operation screen.

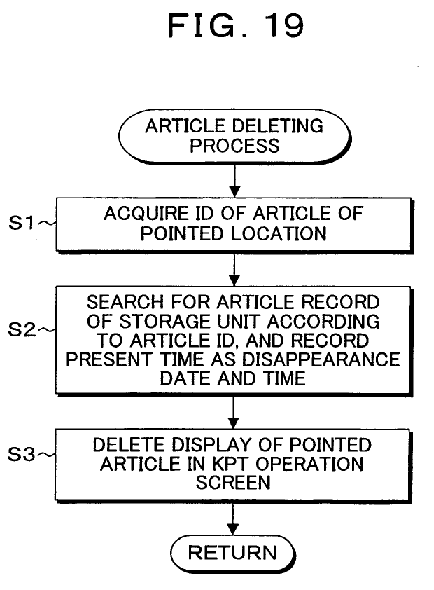

FIG. 19 is a flow chart showing the details of the article deleting process in step S16 of FIGS. 17A to 17C. In FIG. 18, in the article deleting process, the ID of the article at the pointed location is acquired in step S1; and, in step S2, the corresponding article record is searched from the improvement act data table 40 of the storage unit 38 according to the acquired ID, and the date and time of present time is recorded as the disappearance date and time thereof. Subsequently, in step S3, display of the article pointed on the KPT operation screen is deleted.

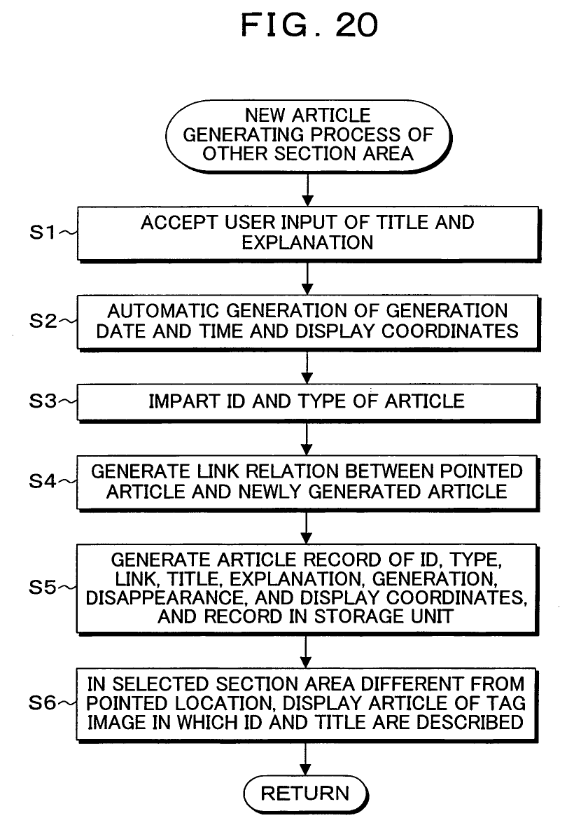

FIG. 20 is a flow chart showing the details of the new article generating process of another section area in step S18 of FIGS. 17A to 17C. In the new article generating process of another section area in FIG. 19, in step S1, user input of a title and an explanation to a new generation inputting screen which is displayed in association with menu selection is accepted. Subsequently, generation date and time and display coordinates are automatically generated for the newly generating article in step S2, and the ID and the type of the article are imparted in step S3. Subsequently, the link relation between the pointed article and the newly generated article of the other area is generated in step S4. Subsequently, in step S5, an article record composed of the ID, type, link, title, explanation, generation date and time, disappearance date and time (blank), and display coordinates is generated and recorded in the improvement act data table 40 of the storage unit 38 of FIGS. 3A and 3B. Subsequently, in step S6, the article of a tag image in which the ID and the title are described is displayed in the selected section area that is different from the pointed location.

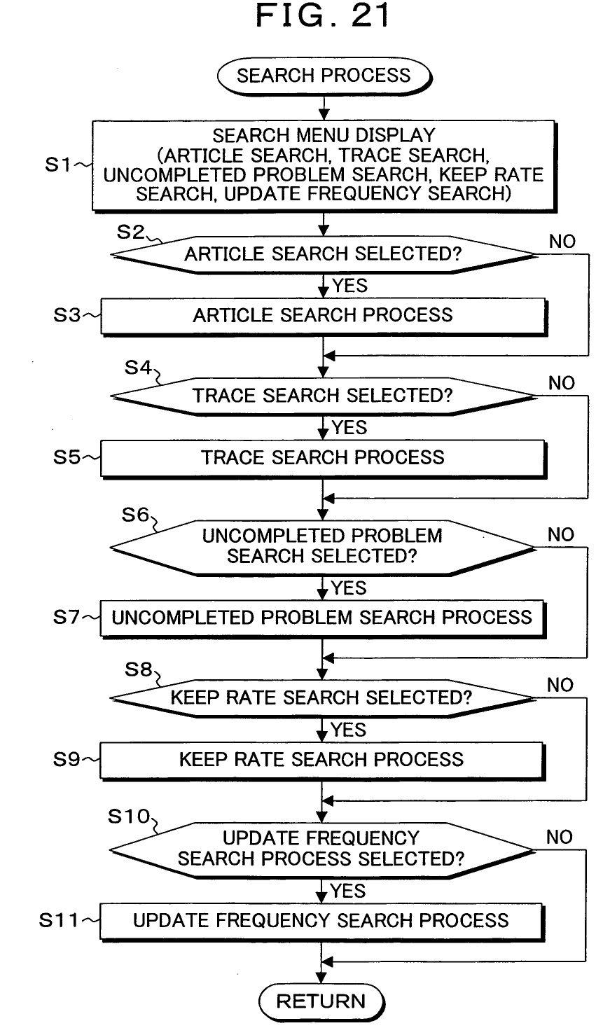

FIG. 21 is a flow chart showing the details of the search process in step S11 of FIG. 13. In the search process of FIG. 21, a search menu is displayed in step S1. The search menu display includes article search, trace search, uncompleted problem search, keep rate search, and update frequency search. When selection of the article search by the user is recognized in step S2, an article search process is executed in step S3. When selection of the trace search is determined in step S4, a trace search process is executed in step S5. When selection of the uncompleted problem search is determined in step S6, an uncompleted problem search process is executed in step S7. When selection of the keep rate search is determined in step S8, a keep rate search-process is executed in step S9. Furthermore, when selection of the update frequency search is determined in step S10, an update frequency search process is executed in step S11.

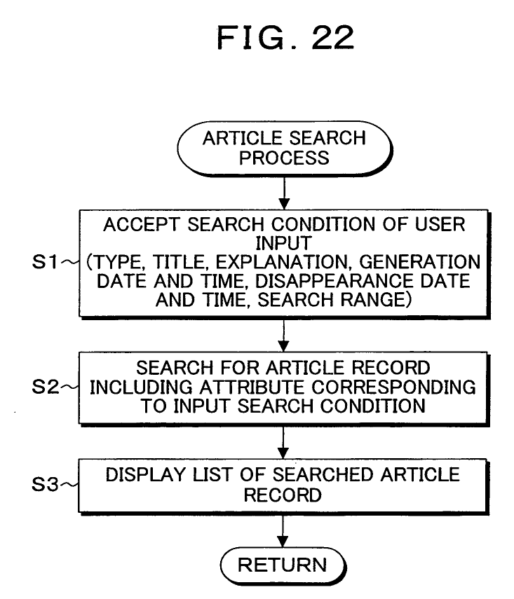

FIG. 22 is a flow chart showing the details of the article search process in step S3 of FIG. 21, and it is executed by the article search unit 56 of FIGS. 3A and 3B.

In FIG. 22, in the article search process, search conditions input by the user are accepted in step S1. The search conditions include the type, title, explanation, generation date and time, disappearance date and time, and search range. The search range is, for example, before an all-range-specifying position or after the specifying position. Next, the improvement act data table 40 of the storage unit 38 of FIGS. 3A and 3B is searched so as to search article records containing the attributes matched with the search conditions in step S2, and a list of the searched article records is displayed in step S3.

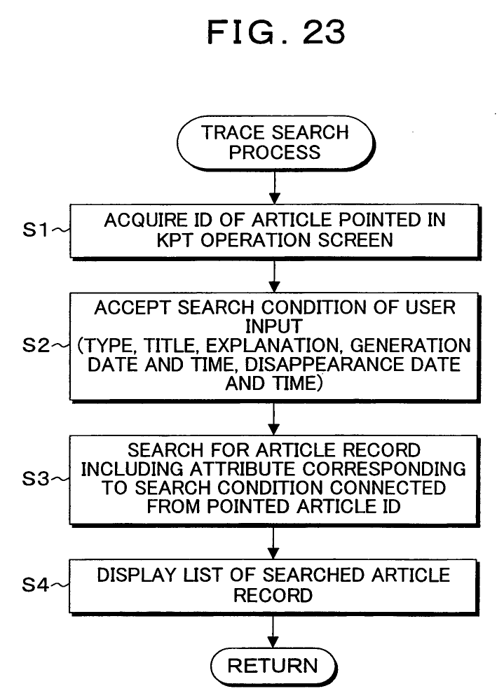

FIG. 23 is a flow chart showing details of the trace search process in step S5 of FIG. 21, and it is executed by the trace search unit 58 of FIGS. 3A and 3B. The trace search process of FIG. 23 is executed by the trace search unit 58 of FIGS. 3A and 3B. In the trace search process, the ID of the article pointed by the user on the KPT operation screen is acquired in step S1, and search conditions of the search input by the user are accepted in step S2. Subsequently, in step S3, the article records including the articles which are connected from the pointed article ID and matched with the search conditions are searched, and a list of the searched article records is displayed in step S4.

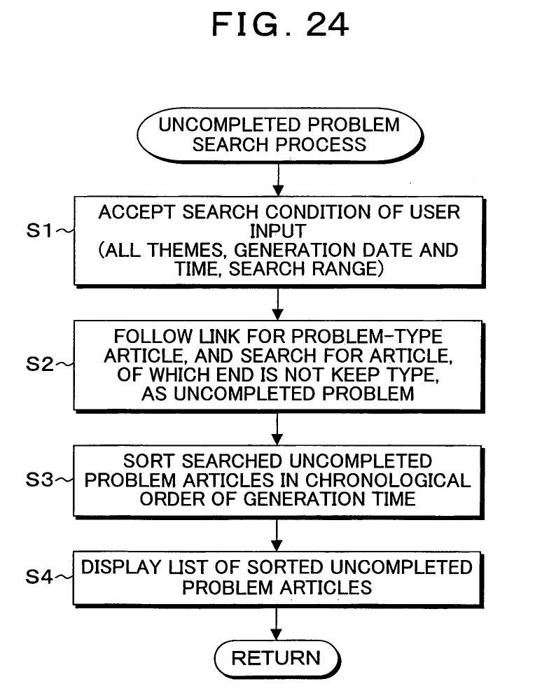

FIG. 24 is a flow chart showing the details of the uncompleted problem search process in step S7 of FIG. 21, and it is executed by the uncompleted problem search unit 60 of FIG. 7. In FIG. 24, in the uncompleted problem search process, after search conditions input by the user are accepted in step S1, links are traced starting from a problem type article so as to search the article of which end is not the keep type as an uncompleted problem in step S2. Subsequently, uncompleted problem articles are sorted in the chronological order of generation date and time in step S3, and a list of the sorted uncompleted problem articles is displayed as a search result in step S4.

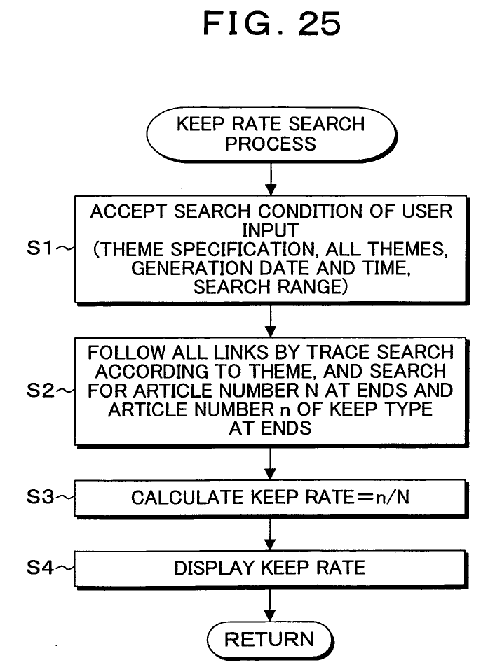

FIG. 25 is a flow chart showing the details of the keep rate search process in step S9 of FIG. 21, and it is executed by the keep rate search unit 62 of FIGS. 3A and 3B. In FIG. 25, in the keep rate search process, search conditions input by the user are accepted in step S1. The search conditions include theme specification, all themes, generation date and time, and search ranges. Subsequently, in step S2, all the links are traced by trace search from the theme so as to search the article number N at the ends and the keep-type article number n at the ends. Subsequently, (n/N) is calculated as a keep rate in step S3, and a list of the keep rates respectively calculated for themes is displayed in step S4.

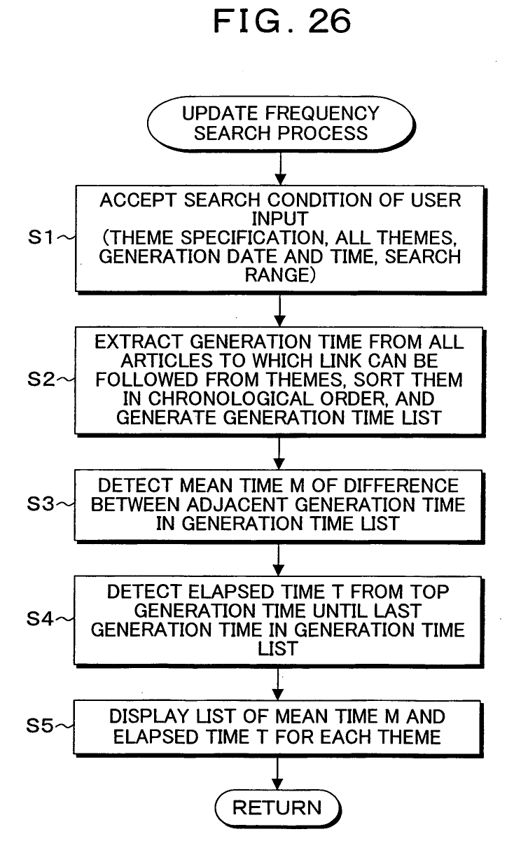

FIG. 27 is a flow chart showing the details of the update frequency search process in step S11 of FIG. 21, and it is a process by the update frequency search unit 64 of FIGS. 3A and 3B. In the update frequency search process of FIG. 27, search conditions input by the user are accepted in step S1. The search conditions include theme specification, all themes, generation date and time, and search ranges. Subsequently, in step S2, generation time is extracted from all the article records traced by the links from the theme, and a list of the generation time is generated by sorting the extracted generation time in the order of time. Next, in step S3, mean time M of the differences between adjacent generation time in the generation time list is detected. Subsequently, in step S4, elapsed time T that is from the generation time at the top to the last generation time in the generation time list is searched for each theme. Subsequently, in step S5, a list of the mean time M and the elapsed time T for each theme is displayed.

The present invention also provides a storage medium storing the improvement act support program, in addition to the improvement act support program, method, and apparatus described in the above described embodiment. Herein, examples of the storage medium includes a CD-ROM, a floppy disk (R), a DVD disk, a magneto-optical disk, a card-type storage medium such as an IC card; a storage apparatus such as a hard disk drive provided inside/outside a computer system; a database which retains programs via a line or another computer system and the database; and a transmission medium on the line thereof.

Note that the above described embodiment employs, as an example, the case in which the management server 14 is provided for the terminal apparatuses 10-1 to 10-5 storing the improvement act support program as shown in FIG. 1 and FIG. 2, and the improvement act data tables in the terminal side are centrally managed by the improvement act database 16; however, instead of centrally managing the improvement act database 16 by the management server 14, group ware may be formed by the terminal apparatuses that the members of the project team have, so that the improvement act data table stored in the terminal apparatus of the group leader is subjected to synchronization management as a master, and the master improvement act data table can be referenced from terminal apparatuses outside the group.

The improvement act support process of the present invention may be realized by a server/client-type system form in which the improvement act support program of the present embodiment is disposed in a server, terminal apparatuses having client functions are provided for the server via a network, and input/output processes with respect to the improvement act support problem are performed as web data in the client side.

The KPT operation screen 112 of the present embodiment shown in FIG. 4 is an example, and an arbitrary display mode can be employed as long as a screen region is divided into a problem area, a try area, and a keep area in the mode.

Many articles are to be disposed and displayed on the KPT operation screen 112, and not all articles can be displayed on the display screen in some cases; therefore, in such a case, arbitrary overlapped display in which, for example, the latest articles in terms of time among the plurality of articles are disposed and displayed in front is employed.

The above embodiment employs, as an example, the case in which each of the members forming the project team uses the terminal apparatus to carry out the improvement act according to the KPT method; however, when they gather at one location such as a management office to carry out the act, a projected screen using a projector apparatus or the like may be shared in the support process.

The present invention is not limited to the above described embodiment, includes modifications that do not impair the object and advantages thereof, and is not limited by the numerical values described in the above described embodiment.

What is claimed is:

1. A computer-readable storage medium which stores an improvement act support program characterized by causing a computer to execute
a display processing step of displaying an improvement act support screen, in which a theme region, a keep region, a problem region, and a try region are disposed, on a display;
an article editing step of processing new generation of articles to be disposed in the theme region, the keep region, the problem region, and the try region, correction of the articles, or deletion of the articles in accordance with an input operation;
a region menu selecting step of, when an operation specifying the problem region, the try region, or the keep region is detected, displaying a new generation menu of an article corresponding to the region and enabling the process of the article editing step when an operation selecting the new generation menu is detected;
an article menu selecting step of, when an operation specifying an article disposed in the problem region, the try region, or the keep region is detected, displaying new generation menus of articles the other regions in addition to a correction menu and a deletion menu of the article and enabling the process of the article editing step when an operation selecting any of the menus is detected; and
an accumulation processing step of associating the problem article, the try article, and the keep article by using the theme article as a starting point and storing the articles in a storage unit.

2. The storage medium according to claim 1, characterized in that, in the article menu selecting step,
when an operation specifying the problem article disposed in the problem region is detected, new generation menus of a try article of the try region and a keep article of the keep region are displayed in addition to a correction menu and a deletion menu of the specified problem article;
when an operation specifying the try article disposed in the try region is detected, new generation menus of a problem article of the problem region and a keep article of the keep region are displayed in addition to a correction menu and a deletion menu of the specified try article; and,
when an operation specifying the keep article disposed in the keep region is detected, new generation menus of a problem article of the problem region and a try article of the try region are displayed in addition to a correction menu and a deletion menu of the specified keep article.

3. The storage medium according to claim 1, characterized in that the article editing step causes
a theme article editing step of processing new generation, correction, or deletion of the theme article to be disposed in the theme region in accordance with an input operation;
a problem article editing step of processing new generation of the problem article of a tag image in which a problematic point or the like is described which is to be disposed in the problem region, correction of the problem article, or deletion of the problem article in accordance with an input operation;
a try article editing step of processing new generation of the try article of a tag image in which an improvement measure or the like to be tried next is described which is to be disposed in the try region, correction of the try article, or deletion of the try article in accordance with an input operation; and
a keep article editing step of processing new generation of the keep article of a tag image in which an improvement measure or the like determined to be continued is described which is to be disposed in the keep region, correction of the keep article, or deletion of the keep article in accordance with an input operation to be executed.

4. The storage medium according to claim 1, characterized in that, in the accumulation processing step, for each article, attribute information including an identifier of the article, a link relation with another article, an article content, an article explanation, generation date and time, disappearance date and time, and screen display coordinates is stored.

5. The storage medium according to claim 1, characterized by further executing a search step of searching the storage unit based on an input search condition and displaying a search result.

6. The improvement act support program according to claim 5, characterized in that the search step includes an article search step of searching the storage unit based on an input article search condition and displaying a search result in a list of an article matched with the search condition.

7. The storage medium according to claim 5, characterized in that the search step includes a trace search step of searching the storage unit based on an operation specifying an article on the improvement act support screen and an input article search condition, tracing a link relation starting from the specified article so as to search an article matched with the search condition, and displaying a list of the article.

8. The storage medium according to n claim 5, characterized in that the search step includes an uncompleted problem search step of searching a problem article of which end is not a keep article by tracing a link relation of each article starting from the theme article and displaying the problem article as an uncompleted problem article in a list in the chronological order of generation time.

9. The storage medium according to claim 5, characterized in that the search step includes a keep rate search step of detecting a total article number N at ends by tracing all link relations starting from the theme article, detecting a keep article number n of keep articles at the ends, and obtaining and displaying a keep rate which is the keep article number n divided by the total article number N.

10. The storage medium according to claim 5, characterized in that the search step includes an update frequency search step of extracting generation date and time of each article by tracing all link relations starting from the theme article, ordering the date and time in the order of time, calculating mean generation time from mean of the difference between adjacent generation date and time, calculating elapsed time from generation date and time of the theme article until generation date and time of a last article, and displaying the mean generation time and the elapsed time in a list.

11. An improvement act support method characterized by including
a display processing step of displaying an improvement act support screen, in which a theme region, a keep region, a problem region, and a try region are disposed, on a display;
an article editing step of processing new generation of articles to be disposed in the theme region, the keep region, the problem region, and the try region, correction of the articles, or deletion of the articles in accordance with an input operation;
a region menu selecting step of, when an operation specifying the problem region, the try region, or the keep region is detected, displaying a new generation menu of an article corresponding to the region and enabling the process of the article editing step when an operation selecting the new generation menu is detected;
an article menu selecting step of, when an operation specifying an article disposed in the problem region, the try region, or the keep region is detected, displaying new generation menus of articles of the other regions in addition to a correction menu and a deletion menu of the article and enabling the process of the article editing step when an operation selecting any of the menus is detected; and
an accumulation processing step of associating the problem article, the try article, and the keep article by using the theme article as a starting point and storing the articles in a storage unit.

12. The improvement act support method according to claim 11, characterized in that, in the article menu selecting step,
when an operation specifying the problem article disposed in the problem region is detected, new generation menus of a try article of the try region and a keep article of the keep region are displayed in addition to a correction menu and a deletion menu of the specified problem article;
when an operation specifying the try article disposed in the try region is detected, new generation menus of a problem article of the problem region and a keep article of the keep region are displayed in addition to a correction menu and a deletion menu of the specified try article; and,
when an operation specifying the keep article disposed in the keep region is detected, new generation menus of a problem article of the problem region and a try article of the try region are displayed in addition to a correction menu and a deletion menu of the specified keep article.

13. The improvement act support method according to claim 11, characterized in that, in the accumulation processing step, for each article, attribute information indicating a link relation with another article, an article content, generation date and time, disappearance date and time, screen display positions, etc. is stored.

14. The improvement act support method according to claim 11, characterized in that the search step includes an article search step of searching the storage unit based on an input article search condition and displaying a search result in a list of an article matched with the search condition.

15. The improvement act support method according to claim 11, characterized in that the search step includes a trace search step of searching the storage unit based on an operation specifying an article on the improvement act support screen and an input article search condition, tracing a link relation starting from the specified article so as to search an article matched with the search condition, and displaying a list of the article.

16. The improvement act support method according to claim 11, characterized in that the search step includes an uncompleted problem search step of searching a problem article of which end is not a keep article by tracing a link relation of each article starting from the theme article and displaying the problem article as an uncompleted problem article in a list in the chronological order of generation time.

17. The improvement act support method according to claim 11, characterized in that the search step includes a keep rate search step of detecting a total article number N at ends by tracing all link relations starting from the theme article, detecting a keep article number n of keep articles at the ends, and obtaining and displaying a keep rate which is the keep article number n divided by the total article number N.

18. The improvement act support method according to claim 11, characterized in that the search step includes an update frequency search step of extracting generation date and time of each article by tracing all link relations starting from the theme article, ordering the date and time in the order of time, calculating mean generation time from mean of the difference between adjacent generation date and time, calculating elapsed time from generation date and time of the theme article until generation date and time of a last article, and displaying the mean generation time and the elapsed time in a list.

19. An improvement act support apparatus characterized by having
a display processing unit which displays an improvement act support screen, in which a theme region, a keep region, a problem region, and a try region are disposed, on a display;
an article editing unit which processes new generation of articles to be disposed in the theme region, the keep region, the problem region, and the try region, correction of the articles, or deletion of the articles in accordance with an input operation;
a region menu selecting unit which, when an operation specifying the problem region, the try region, or the keep region is detected, displays a new generation menu of an article corresponding to the region and enables the process of the article editing unit when an operation selecting the new generation menu is detected;
an article menu selecting unit which, when an operation specifying an article disposed in the problem region, the try region, or the keep region is detected, displays new generation menus of articles of the other regions in addition to a correction menu and a deletion menu of the specified article and enables the process of the article editing unit when an operation selecting any of the menus is detected; and
an accumulation processing unit which associates the problem article, the try article, and the keep article by using the theme article as a starting point and stores the articles in a storage unit.

20. The improvement act support apparatus according to claim 19, characterized in that, the article menu selecting unit
displays, when an operation specifying the problem article disposed in the problem region is detected, new generation menus of a try article of the try region and a keep article of the keep region in addition to a correction menu and a deletion menu of the specified problem article;
displays, when an operation specifying the try article disposed in the try region is detected, new generation menus of a problem article of the problem region and a keep article of the keep region in addition to a correction menu and a deletion menu of the specified try article; and,
displays, when an operation specifying the keep article disposed in the keep region is detected, new generation menus of a problem article of the problem region and a try article of the try region in addition to a correction menu and a deletion menu of the specified keep article.
